(19) United States
(12) Patent Application Publication
(10) Pub. No.: US 2012/0191364 A1
(43) Pub. Date: Jul. 26, 2012

(54) METHODS AND ARRAYS FOR DNA SEQUENCING

(76) Inventors: Wing Cheong Christopher Wong, Singapore (SG); Wah Heng Charlie Lee, Singapore (SG); Wing Kin Sung, Singapore (SG); Martin Lloyd Hibberd, Singapore (SG)

(21) Appl. No.: 13/499,265

(22) PCT Filed: Sep. 29, 2010
(86) PCT No.: PCT/SG2010/000371

§ 371 Date: Mar. 29, 2012

(30) Foreign Application Priority Data
Sep. 29, 2009 (SG) 200906588-9

(51) Int. Cl. G06F 19/00; C40B 40/06

(52) U.S. Cl. 702/19; 506/16

(57) ABSTRACT

A method of sequencing a first polynucleotide strand having a first polynucleotide sequence, the first polynucleotide strand resembling a second polynucleotide strand having a known second polynucleotide sequence, the method employing a data set which, for one or more fragment(s) of the second polynucleotide sequence, contains: for each position along each said fragment: (i) first probe data describing the hybridization intensity of the first polynucleotide strand with a respective first probe designed to bind to a portion of the second polynucleotide strand centered at said position; and (ii) second probe data describing the respective hybridization intensities of the first polynucleotide strand with each of a set of second probes, each said second probe being designed to bind with a respective mutation of the corresponding portion of the second polynucleotide sequence which is formed by mutating the corresponding portion of the second polynucleotide sequence at said position, the data set including said second probe data for every possible said mutation; the method comprising: for each said position, obtaining from the dataset a first numerical parameter characterizing the hybridization intensity of the first polynucleotide strand with the corresponding first probe in comparison to the hybridization intensities of the first polynucleotide strand with the corresponding second probes; said first numerical parameter being indicative of whether a nucleic acid of the first polynucleotide sequence is equal to a nucleic acid the second polynucleotide sequence at said position.

### FIELD OF THE INVENTION

The present invention relates to a method of DNA sequencing and in particular but not exclusively to methods and arrays for nucleotide base calling.

### BACKGROUND TO THE INVENTION

Every year there is an exponential growth in the amount of DNA sequence information generated and deposited into Genbank. Many of the current sequencing technologies use a form of sequencing by synthesis (SBS), wherein specially designed nucleotides and DNA polymerases are used to read the sequence of chip-bound, single-stranded DNA templates in a controlled manner. To attain high throughput, many millions of such template spots are arrayed across a sequencing chip and their sequence is independently read out and recorded. Devices, equations, and computer systems for making and using arrays of material on a substrate for DNA sequencing are known. However, there is a continued need for methods and compositions for increasing the fidelity and accuracy of sequencing nucleic acid sequences.

Sequencing of viral genomes in particular has historically been performed using standard dye termination technologies. In recent years, many researchers have migrated away from traditional capillary sequencing instruments and towards high-throughput DNA sequencing technologies that provide higher accuracy at a lower cost. However, these technologies are still too slow, costly and labour-intensive to obtain genomic sequences of viruses that mutate ever so frequently and for large-scale epidemiologic or evolutionary investigations in viral outbreaks. For example, the currently available sequencing technology is not suitable for sequencing the genomic sequences of H1NA influenza A virus and in particular the 2009 influenza A (H1N1) virus from the ever-increasing pool of infected individuals.

In April 2009, a novel swine-origin H1N1 influenza A virus erupted in Mexico and spread swiftly across the world at unprecedented speed, forcing the World Health Organization (WHO) to raise its pandemic alert to phase 5. As of September 13th, WHO had reported over 2,96,471 laboratory-confirmed cases of pandemic (H1N1) 2009 in 135 countries. However, these figures are likely to be an underestimate as surveillance has been focused on severe cases. Fortunately, despite the high transmissibility of this outbreak, there has been a low number of fatalities (3,486 reported deaths). This suggests that the virulence of the 2009 influenza A (H1N1) virus may be relatively low.

The influenza pandemics of 1918, 1957, and 1968 that killed millions of people remind us that the most recent 2009 influenza A (H1N1) virus outbreak should not be taken lightly. This virus will continue to evolve through mutations and/or recombination that may increase its virulence and/or drug resistance of the virus. As drug companies rush to supply the world with antiviral drugs for this pandemic outbreak, isolated cases of drug-resistant H1N1 flu strains have already emerged. These drug-resistant strains usually have mutations near drug-binding sites that reduce the binding affinities and effectiveness of certain drugs. Thus, it is absolutely vital that the evolution of the 2009 influenza A(H1N1) viruses be closely and continually monitored for any genetic variations.

Oligonucleotide resequencing microarrays that are capable of identifying nucleotide sequence variants may offer an alternative solution to the standard dye termination technologies and in recent years, have been used for detecting and subtyping influenza viruses. By analysing sequences generated from tiling probes across targeted regions of various strains of the influenza virus (e.g. partial fragments of the haemagglutinin (HA) and neuraminidase (NA) genes), important information such as viral subtypes, lineages and sequence variants can be determined. Analysis of the sequences is usually done using platform accompanying software that employs probabilistic base-calling algorithms such as ABACUS and Nimblescan PBC. Although statistically sound, these methods are susceptible to hybridization noise caused by factors such as poor probe quality, poor amplification or mutations. This results in numerous ambiguous and false positive base calls that may affect the accuracy of downstream evolutionary analysis. Efforts have been made to improve the call rates and accuracies of existing probabilistic base-calling algorithms but the methods mostly result in the base call rates suffering.

Also, ideally during sequencing, a perfect match (PM) probe used in the sequencing, would be expected to gain a hybridization intensity multi-fold that of its corresponding mismatch (MM) probes, making base calling a straight-forward task. However, two types of errors are prevalent in practice:
I. The PM probe and its corresponding MM probes have similar hybridization intensities
II. One or more MM probes may have higher hybridization intensities than the PM probe.

A myriad of factors, such as weak PCR products, suboptimal annealing temperatures, CG biases, poor probe quality, and non-specific binding of MM probes have been attributed to be the causes of these two types of errors. With the use of better primers, optimization of annealing temperatures and the use of variable length probes, certain factors such as weak PCR products and CG biases can be overcome. However, some factors are unavoidable. This implies that even under optimal experimental conditions, there may still exists MM probes that do not exhibit a significant reduction in hybridization intensity relative to the PM probe, causing a type I error. The tiling requirement of a resequencing array also greatly inhibits the exclusion of poor quality probes from the array. For example, the inclusion of probes that are of low complexity or containing consecutive runs of the same nucleotide (homopolymers) are likely to cause type II errors since they have a higher tendency to exhibit non-specific cross-hybridization.

These factors affect the hybridization intensities of the PM/MM probes has proved useful in designing probes for microarray experiments however, the accuracy of sequence calling has yet to be improved.

### SUMMARY OF THE INVENTION

The present invention is defined in the appended independent claim. Some optional features of the present invention are defined in the appended dependent claims.

In general terms, the invention sequencing a first polynucleotide strand (e.g. a strand of a virus which is believed to have mutated) using the known polynucleotide structure of a second polynucleotide strand (e.g. the virus before mutation). For each of a number of fragments of the second polynucleotide strand, and for each position along each fragment, we obtain (i) “first probe data” describing the hybridization activity of the first polynucleotide strand with a “first probe” designed to bind with a portion of the second polynucleotide strand centred at that position, and (ii) “second probe data” describing the hybridization of the first polynucleotide strand with “second probes” which differ from the first probe only at that position. In positions where the hybridization with the first probe is much greater than with the second probe, it is likely that the first and second polynucleotides are the same. In other positions, there is a higher chance of a mutation.

In one specific expression, the present invention relates to a method of sequencing a first polynucleotide strand comprising a first polynucleotide sequence, the first polynucleotide strand resembling a second polynucleotide strand having a known second polynucleotide sequence, the method employing a data set which, for one or more fragments of the second polynucleotide sequence, contains:
for each position along each said fragment:
(i) first probe data describing the hybridization intensity of the first polynucleotide strand with a respective first probe designed to bind to a portion of the second polynucleotide strand centered at said position; and
(ii) second probe data describing the respective hybridization intensities of the first polynucleotide strand with each of a set of second probes, each said second probe being designed to bind with a respective mutation of the corresponding portion of the second polynucleotide sequence which is formed by mutating the corresponding portion of the second polynucleotide sequence at said position, the data set including said second probe data for every possible said mutation;
the method comprising:
for each said position, obtaining from the dataset a first numerical parameter characterizing the hybridization intensity of the first polynucleotide strand with the corresponding first probe in comparison to the hybridization intensities of the first polynucleotide strand with the corresponding second probes;
said first numerical parameter being indicative of whether a nucleic acid of the first polynucleotide sequence is equal to a nucleic acid of the second polynucleotide sequence at said position.

The method of the present invention may enable large-scale identification of variations in polynucleotide sequences. In particular, it may enable large-scale identification of variations in viruses. This may be advantageous especially with H1N1 (2009) viruses which mutate easily and frequently and may vary in multiple patient samples. The method of the present invention may provide a means for rapidly whole-genome sequencing the H1N1 samples.

The term “fragment” is used here to refer to a part (i.e. a sub-set) of the second polynucleotide strand, with no implication that the fragment has been separated from the rest of the second polynucleotide strand. Preferably the set of fragments collectively span the entire second polynucleotide strand (in the sense that every base in the second polynucleotide strand is included within at least one of the fragments), so that if the first polynucleotide strand differs from the second polynucleotide strand only by mutations, the method may be used to sequence substantially the whole of the first polynucleotide strand (also, in some instances, as discussed below, at certain isolated positions, the method may determine that no identification of the base is possible). Alternatively, the fragments may be selected such that they do not span the entire second polynucleotide strand (e.g. to omit portions of the polynucleotide strand which are not believed to be of clinical importance).

The first probe is “designed to bind to a portion of the second polynucleotide strand” in the sense of having a sequence complementary to that portion of the second polynucleotide strand.

The one of the first and second probes which is complementary to the first nucleotide strand at the central position (i.e. the probe with the highest hybridization, activity) is called the “perfect match probe”, and the other probes are called “mismatch probes”. In the case that the corresponding portion of the first polynucleotide strand does not contain a mutation, the “first probe” is the “perfect match probe”, and the second probes are the mismatch probes. Conversely, if there is a mutation at the central position, then the corresponding one of the second probes is the “perfect match probe”, and the first probe and the other second probes are the mismatch probes.

In one embodiment, the method further comprises at each said position,
obtaining at least one corresponding second numerical parameter indicative of data abnormalities in the first probe data and second probe data relating to said position;
determining whether:
(i) said first numerical parameter indicates that the nucleic acid of the first polynucleotide sequence is equal to the nucleic acid of the second polynucleotide sequence at said position; and
(ii) said at least one second numerical parameter does not indicate abnormalities in the first probe data and the second probe data; and
if said determinations are both positive, determining that the nucleic acid of the first nucleotide sequence is equal to the nucleic acid of the second nucleotide sequence at said position.

The said at least one second numerical parameter for each said position may include a parameter comparing the mean and the standard deviation of the corresponding first probe data and second probe data. If either of said determinations is negative, a verification algorithm may be performed using data (“perfect match data”) describing the hybridization intensity of the perfect match probe of neighbouring positions.

The verification algorithm may comprise a first determination of whether the perfect match data for the neighbouring positions is indicative of a divergence between the first and second nucleotide sequences at said position. The first determination may be positive if the average of the perfect match data for one or more nearest neighbouring positions is lower than the perfect match data for neighbouring positions further from said position than said nearest neighboring positions.

Alternatively or additionally, the verification algorithm may comprise a second determination of whether there is a likelihood of a substitution bias at said position. One of said second numerical parameters may be obtained from the hybridization intensity-based order of the PM probe and mismatch probes for the site. Suppose that, for a given position, we say that a given probe encodes base b if b is located at the centre of the region. We denote the base encoded by the PM probe as b₁ and the mismatch probes encode b₂, b₃ and b₄ where {b₁, b₂, b₃, b₄}={A, C, G, T}. Without loss of generality, we will assume that hybridization intensity reduction order is b₁b₂b₃, b₄. The second numerical parameter may then be obtained as a ratio f_{obs}/f_{rand}, where f_{obs} is a probability of observing the hybridization intensity reduction order b₁b₂b₃b₄ given that the perfect match probe encodes b₁, and f_{rand}, is the probability of observing the hybridization intensity reduction order b₁b₂b₃b₄ by chance.

The values f_{obs} and f_{rand} may be obtained by calculating:

$${f}_{obs} = \frac{\# ( {b}_{1} {b}_{2} {b}_{3} {b}_{4} )}{\begin{matrix}\# ( {b}_{1} {b}_{2} {b}_{3} {b}_{4} ) + \# ( {b}_{1} {b}_{2} {b}_{4} {b}_{3} ) + \# ( {b}_{1} {b}_{3} {b}_{2} {b}_{4} ) + \\ \# ( {b}_{1} {b}_{3} {b}_{4} {b}_{2} ) + \# ( {b}_{1} {b}_{4} {b}_{2} {b}_{3} ) + \# ( {b}_{1} {b}_{4} {b}_{3} {b}_{2} )\end{matrix}} , \\ and$$

$${f}_{rand} = \frac{\# ( {b}_{1} {b}_{2} )}{t} \times \frac{\# ( {b}_{2} {b}_{3} )}{t} \times \frac{\# ( {b}_{3} {b}_{4} )}{t} ,$$

wherein, for any order of the bases denoted by wxyz, the function #(wxyz) denotes the number of times, in a number t of other positions, that the hybridization intensity reduction order was wxyz. Preferably the t positions are those in which the first numerical parameter indicated that the first and second nucleotide strands were both b₁, and #(wx) denotes the number of times, in the t positions that the hybridization order began wx. For example, #(b₁b₂)=#(b₁b₂ b₃b₄)+#(b₁b₂ b₄ b₃).

Upon said first determination being positive and said second determination being negative, it may be determined that the nucleic acid of the first polynucleotide sequence differs from the nucleic acid of the second polynucleotide sequence at said position.

In another specific expression, the present invention relates to a method of sequencing a pair of first polynucleotide strands, which are complementary strands having complementary first polynucleotide sequences. In particular, in, the pair of strands, one strand has the first polynucleotide sequence and the other strand has a polynucleotide sequence complementary to the first polynucleotide sequence. The method comprises performing a method according to any aspect of the present invention for each first polynucleotide strand using a respective second polynucleotide strand, the second polynucleotide strand having complementary respective second polynucleotide sequence, for each corresponding position in the second polynucleotide sequence, said verification algorithm may be performed upon a determination that said first numerical parameters are indicative of the two first polynucleotide sequences not being complementary in that position.

As mentioned above, the set of fragments of the second polynucleotide sequence may collectively span the entire polynucleotide strand. Preferably, the fragments overlap to some degree, so that the dataset contains multiple sets of perfect match data and mismatch data for locations in the overlap regions. This data may be averaged before calculating the first numerical parameter in respect of such positions. Preferably, the overlap regions are selected to include regions considers to be critical in the sense given below, so that more accurate sequencing of the critical regions is possible.

In one expression, the present invention relates to a method of producing an array for sequencing a first polynucleotide strand having a first polynucleotide sequence, the method employing data encoding a second polynucleotide sequence of a polynucleotide strand resembling the first polynucleotide strand, the method comprising:
(a) defining one or more fragments of the second polynucleotide sequence,
(b) constructing the array, the array comprising:
   (i) for each position along each said fragment of the second polynucleotide sequence, a first probe designed to bind to a portion of the second polynucleotide sequence centred at said position; and
   (ii) for each first probe, a plurality of second probes, each said second probe being designed to bind with a respective mutation of the corresponding portion of the second polynucleotide sequence which is formed by mutating the second polynucleotide sequence at said position, there being a respective said second probe for every possible said mutation.

Step (a) of defining the one or more fragments may include:
identifying one or more critical regions of said second polynucleotide sequence, and
defining at least one of said fragments to include at least one of said critical regions;
said critical regions being any one or more of:
(i) drug-binding sites;
(ii) structural components; and
(ii) mutation hotspots.

The method above may be implemented by a computer (e.g. any general purpose computer, such as a PC) having a processor and a data storage device containing program instructions operable by the processor to carry out the method. Furthermore, a computer program product (e.g. a software download, or a tangible data storage device, such as a CD-ROM) may be provided containing such program instructions.

In another expression, the present invention relates to an array for sequencing a first polynucleotide strand having a first polynucleotide sequence and resembling a second polynucleotide strand having a second, known polynucleotide sequence, the array comprising, for each of one or more fragments of the second polynucleotide sequence:
(i) for each position along each said fragment of the second polynucleotide sequence, a first probe designed to bind to a portion of the second polynucleotide sequence centred at said position; and
(ii) for each first probe, a plurality of second probes, each said second probe being designed to bind with a respective mutation of the corresponding portion of the second polynucleotide sequence which is formed by mutating a nucleic acid of the second polynucleotide sequence at said position, there being a respective said second probe for every possible said mutation.

These arrays may be used as a practical, large-scale re-sequencing tool. Also, the sequences obtained from the arrays may also be highly reproducible.

The dataset may be derived using an array which may be produced by a method according to any aspect of the present invention and/or an array according to any aspect of the present invention.

The second polynucleotide strand may be a RNA or DNA of a virus. In particular, the virus may be influenza A virus. More in particular, the virus may be H1N1 influenza A virus.

In another expression, the present invention relates to a kit comprising:
(a) RT-PCR primers used for amplification,
(b) the array according to any aspect of the present invention, and
(c) a computer readable medium capable of carrying out the method of sequencing according to any aspect of the present invention.

Preferably, the computer readable medium may be fully-automated and may provide a comprehensive graphical report that shows the first polynucleotide sequence quality and the location of all mutations with their associated confidence and proximity to the important regions in the first polynucleotide strand. The short turnaround time from sample to sequence and analysis results may also be short. For example, it may take approximately 30 hours for 24 samples, making this kit an efficient large-scale evolutionary surveillance tool.

The array may be a 12-plex array. The kit may be used for sequencing H1N1 influenza A virus. In particular, the H1N1 influenza A virus may be 2009 influenza A(H1N1) virus. More in particular, the computer readable medium may be used for automatic base-calling and variant analysis, capable of interrogating all eight segments of the 2009 influenza. A(H1N1) virus genome and its variants. The array according to any aspect of the present invention may be able to detect all sequence variations with respect to a second polynucleotide strand with a second polynucleotide sequence. In particular, the second polynucleotide sequence may be a consensus 2009 influenza A(H1N1) virus sequences with added focus on important regions such as drug-binding sites, structural components and previously reported mutations.

The consensus 2009 influenza A (H1N1) may comprise at least one sequence selected from the group consisting of SEQ ID NO:1 to SEQ ID NO:8, fragment(s), derivative(s), mutation(s), and complementary sequence(s) thereof. In particular, the consensus 2009 influenza A (H1N1) may consists of nucleotide sequences SEQ ID NO:1 to SEQ ID NO:8.

In another expression, the present invention relates to isolated oligonucleotide comprising at least one nucleotide sequence selected from the group consisting of: SEQ ID NO:1 to SEQ ID NO:8, fragment(s), derivative(s), mutation(s), and complementary sequence(s) thereof. The sequences may be derived from H1N1 influenza A.

As will be apparent from the following description, preferred embodiments of the present invention allow an optimal use of the method of the present invention to take advantage of the accuracy, speed and reproducibility. This and other related advantages will be apparent to skilled persons from the description below.

### BRIEF DESCRIPTION OF THE FIGURES

Preferred embodiments of a method of DNA sequencing will now be described by way of example with reference to the accompanying figures in which:

FIG. 1 is a flowchart of Evolution Surveillance and Tracking Algorithm for Resequencing Arrays (EvoISTAR),

FIG. 2 is a detailed flowchart of EvoISTAR. Bold arrows represent ‘Yes’ paths, while normal arrows represent ‘No’ paths. In the first step, sites are found at which the data gives good support to the view that a strand being sequenced conforms to the sequence of a known strand; for other sites, step 2 is carried out,

FIG. 3 is a summary of characteristics of neighbourhood hybridization intensity profiles (NHIP) for different type of calls. Five distinct types of NHIP patterns are shown. The query base is at position 0 while neighbourhood probes (±6 bases) are numbered according to their distance away from the base query position. Dark Grey circles represent the PM probe of the query base, and black circles represent neighbourhood PM probes. (a) True non-mutation, (b) True-Mutation, (c) Isolated error or “N”, (d) Poor quality region (i.e. long chains of consecutive errors) or ‘N’, (e) Unknown error or “N”,

FIG. 4 is a graph of the accuracy of base calls with respect to fold change (Perfect Match Probe (PM)/Mismatch Probe (MM) hybridisation intensity). For all resequencing experiments, a fold change (PM/MM) threshold of 1.4 is sufficient to achieve ≦99% matches with capillary and 454 sequencing,

FIG. 5 is an observed NHIP for true-non-mutation calls. A representative set of observed NHIPs for true-non-mutation calls from patient sample 380. This representative set consists of five true-non-mutation calls randomly selected from each segment. Each line represents the NHIP (±6 bp from query base position) of a true-non-mutation call,

FIG. 6 is an observed NHIP for true-mutation calls. The observed NHIPs for all 10 identified true-mutation calls from patient sample 380,

FIG. 7 is an observed NHIP for isolated error/‘N’ calls. The observed NHIPs for all three identified isolated error/‘N’ calls from patient sample 380. These errors are flanked by true (correct) calls,

FIG. 8 is an observed NHIP for long consecutive error/‘N’ calls. The observed NHIPs for five regions where there are long consecutive (≅5) error/‘N’ calls from patient sample 380,

FIG. 9 is an observed NHIP for unknown error/‘N’ calls. A representative set of observed NHIPs for unknown error/‘N’ calls from patient sample 380. This representative set consists of two unknown error/‘N’ calls randomly selected from each segment,

FIG. 10 is a graphical visualization of sequence calls made by EvoISTAR of a first sample. Sequence calls are represented by bars that are colour-coded based on their percentage matches with the reference sequences. Mutations are marked by black (high confidence) or light grey (low confidence) triangles. Drug binding sites are marked by white circles in the neuraminidase (NA) gene (Segment 6). A heat map bar is used to represent the quality and coverage of its sequence calls. Sequences with coverage<90% are automatically flagged as ‘low coverage’. Other details such as coverage: percentage of base calls successfully made, match: number of base calls that match the reference sequence i.e. non-mutation base calls, strong mismatch: number of high confidence base calls that do not match the reference sequence i.e. mutation base calls, weak mismatch: number of low-confidence base-calls that do not match the reference sequence i.e. mutation base calls and Ns: number of ‘N’ calls, for each sequence call are also shown on the visualization map,

FIG. 11 is a graphical visualization of sequence calls made by EvoISTAR of a second sample. The visualization map of all eight segments of the 2009 influenza A(H1N1) virus and the locations of known drug binding sites (marked with white lines) on the neuraminidase (NA) gene (segment 6) are shown. The remaining features are the same as those represented in FIG. 10,

FIG. 12 is a visualization map of a 2009 influenza A (H1N1) virus with artificial reassortment of H3N2 segment 4. The segments 1, 2, 3, 5, 6 and 7 of the 2009 influenza A(H1N1) virus and segment 4 of a H3N2 influenza A virus were independently amplified and hybridized them onto an array. As expected, the sequence call for segment 4 (based on PM/MM probes from the segment 4 consensus of the 2009 influenza A(H1N1) virus) is poor in quality and coverage.

### DETAILED DESCRIPTION OF THE PREFERRED EMBODIMENTS

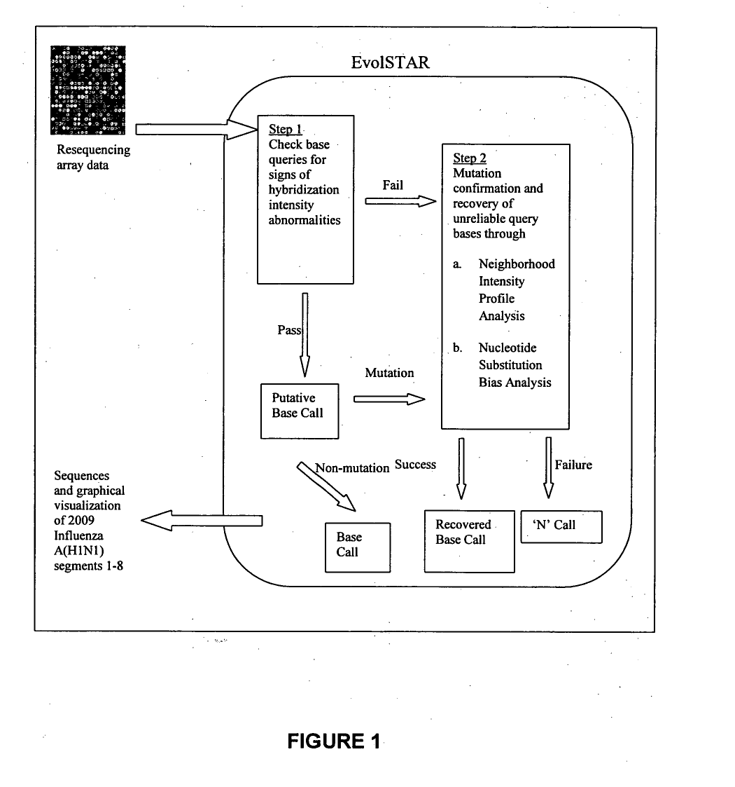

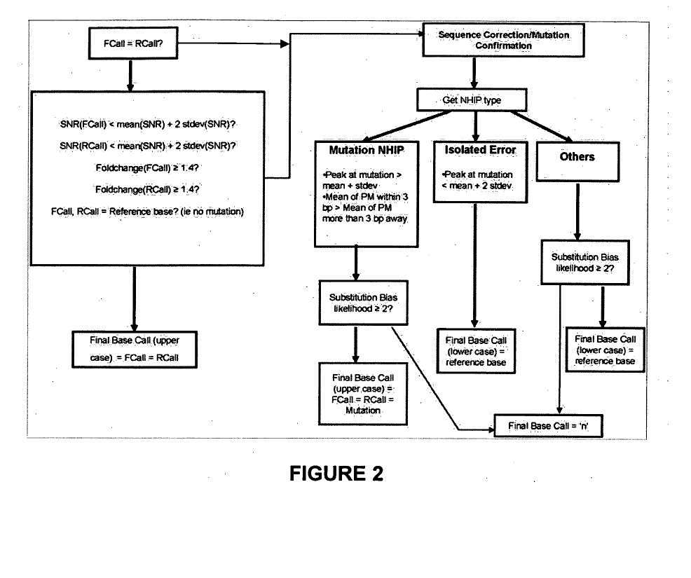

FIGS. 1 and 2 show a flowchart of an embodiment of a method of sequencing a first polynucleotide strand having a first polynucleotide sequence, the first polynucleotide strand resembling a second polynucleotide strand having a known second polynucleotide sequence, the method employing a data set which, for one or more fragment(s) of the second polynucleotide sequence, contains:
for each position along each said fragment:
   (i) first probe data describing the hybridization intensity of the first polynucleotide strand with a respective first probe designed to bind to a portion of the second polynucleotide strand centered at said position; and
   (ii) second probe data describing the respective hybridization intensities of the first polynucleotide strand with each of a set of second probes, each said second probe being designed to bind with a respective mutation of the corresponding portion of the second polynucleotide sequence which is formed by mutating the corresponding portion of the second polynucleotide sequence at said position, the data set including said second probe data for every possible said mutation;
the method comprising:
   for each said position, obtaining from the dataset a first numerical parameter characterizing the hybridization intensity of the first polynucleotide strand with a corresponding first probe in comparison to the hybridization intensities of the first polynucleotide strand with the corresponding second probes;
said first numerical parameter being indicative of whether a nucleic acid of the first polynucleotide sequence is equal to a nucleic acid the second polynucleotide sequence at said position.

The term, “resembling” is used herein to refer to a measure of similarity. In particular, it refers to the measure of similarity between the first polynucleotide strand and the second polynucleotide strand: For example, the polynucleotide sequence of the first strand may vary from the polynucleotide sequence of the second strand by 1-20 nucleotides. In particular, the polynucleotide sequence of the first strand may vary from that of the second strand by 1, 2, 3, 4, 5, 10 or 15 nucleotides. The polynucleotide sequence of the first strand may be 95-99% similar to the polynucleotide sequence of the second strand.

The term “fragment” is used herein to refer to a portion of the second polynucleotide strand. In particular, the fragment may refer to a sequence of the polynucleotide that is at least 5 nucleotides long. More in particular, the fragment may refer to a sequence of the second polynucleotide strand that is 5, 8, 10, 15, 20, 25, or 25 nucleotides long. It may also refer to a longer fragment, such as an entire segment of the virus, and thus be up to several hundred or thousand nucleotides long.

The term “second polynucleotide strand” is used herein to refer to a reference sequence or part thereof. The second polynucleotide strand may be a consensus sequence and/or a known sequence used as a reference to determine the polynucleotide sequence of the first nucleotide strand.

The term “nucleic acid” is used herein to includes, but is not limited to, a monomer that includes a base linked to a sugar, such as a pyrimidine, purine or synthetic analogs thereof, or a base linked to an amino acid, as in a peptide nucleic acid (PNA). A nucleotide is one monomer in a polynucleotide. A nucleotide sequence refers to the sequence of bases in a polynucleotide.

The term “polynucleotide” is used herein to refer to a nucleic acid sequence (such as a linear sequence) of any length. Therefore, a polynucleotide includes oligonucleotides, and also gene sequences found in chromosomes. The term “polynucleotide” also encompassed RNA or DNA, as well as mRNA and cDNA corresponding to or complementary to the RNA or DNA. A fragment of a polynucleotide is a shortened length of the polynucleotide.

The term “mutation” of a position in the first polynucleotide sequence, refers at least one nucleic acid that varies from at least one reference (second) sequence via substitution, deletion or addition of at least one nucleic acid. In particular, the mutants may be naturally occurring or may be recombinantly or synthetically produced.

This method of sequencing is a platform-independent automated method for sequence calling that analyzes data from results of any array. The method adopts a gain-of-signal approach which assumes that the signal intensity of the perfect match (PM) probe (which matches exactly to the polynucleotide sequence in a sample) will be significantly higher than that of the corresponding mismatch (MM) probes. Hence, base calls are made by quantifying the gain in hybridization intensities of a PM probe over its corresponding MM probes. Using this method, an indication of the type of error in a suspicious base call is determined and the true PM probe may be discerned from the noisy MM probes.

The flowchart of the two-step process for base-calling is shown in FIGS. 1 and 2. In the “step 1” of FIG. 1, each base query is scrutinized for signs of hybridization intensity abnormalities. In particular, step 1 attempt to identify (calls) all bases with confidence. In most cases, the query base is easily determined when complementary PM probes of both the forward and reverse strands having hybridization intensities multi-fold that of its corresponding MM probes. Such base calls are known as high confidence calls. Traditional statistical and probabilistic sequence-calling techniques ascertain that a base call is of high confidence if they exceed some pre-defined significance or probability thresholds.

The remaining bases (i.e. Base queries with hybridization intensity abnormalities) are then passed to step 2 of FIG. 1 for further analysis. In the second step, the method according to the present invention (EvoISTAR) is then used to recover base queries that have any hybridization intensity abnormalities indicative of type I or II errors by employing several key observations and novel heuristics. This step is also used to determine the validity of a mutation call which cannot be purely based on the distribution of hybridization intensities of its PM and MM probes.

FIG. 2 represents the same process as in FIG. 1, but in more detail. In FIG. 2, the bold arrows represent ‘Yes’ paths, while normal arrows represent ‘No’ paths. The first step shown in FIG. 2 is one which is not explicit in FIG. 1, in which there is a test of whether the left and right strands lead to the two complementary probes having the highest hybridization intensity.

If not, the method passes to a sequence correction step.

The terms “base query” and “query base” are interchangeably used and are herein used to refer to a nucleic acid in a sequence that is not known and/or shows signs of hybridization intensity abnormalities. The base query refers to a position in the first polynucleotide strand that is to be determined using the method according to any aspect of the present invention.

All base queries with type I or II errors are assumed to have the following characteristics:

1. The base derived from the PM probe in the forward strand is not the same as the base derived from the PM probe in the reverse strand,
2. In either or both of the forward or reverse strands, the putative PM probe (the probe with the highest hybridization intensity) does not have hybridization intensity significantly higher than that of its MM probes,
3. One or more of its eight querying probes at any one position have unusually low signal-to-noise ratio. For a probe, its signal-to-noise ratio is defined as the ratio of the mean to the standard deviation of the intensities of the 9 pixels on the array encoding the probe.

Under optimized experimental conditions, the average percentage of high confidence calls made per sample is approximately 93%. Thus the number of non-high confidence calls (7%) can still seriously undermine the reliability of sequences generated by an array. Thus, it is imperative that these problematic queries be identified and subjected to further analysis.

The second step specifically comprises mutation confirmation and recovery of unreliable base queries through: neighbourhood hybridization intensity profile (NHIP) analysis and nucleotide substitution bias analysis.

In step 2, to extract any information out of noisy base calls, and unreliable base calls and to obtain more assurances of putative mutation calls, hybridization intensity patterns are used. Since a high-confidence mutation call may be a result of coincidental non-specific hybridization of the same MM probe in both strands, it is important to validate the mutation.

Many factors that cause noise in resequencing arrays do not only affect a single isolated query base. For example, if a region of the sample sequence is not amplified efficiently by PCR, the query bases in the region will be erroneous. As another example, when a single nucleotide mutation occurs at a particular query base, it may affect the hybridization intensities of probes belonging to neighbouring query bases as well.

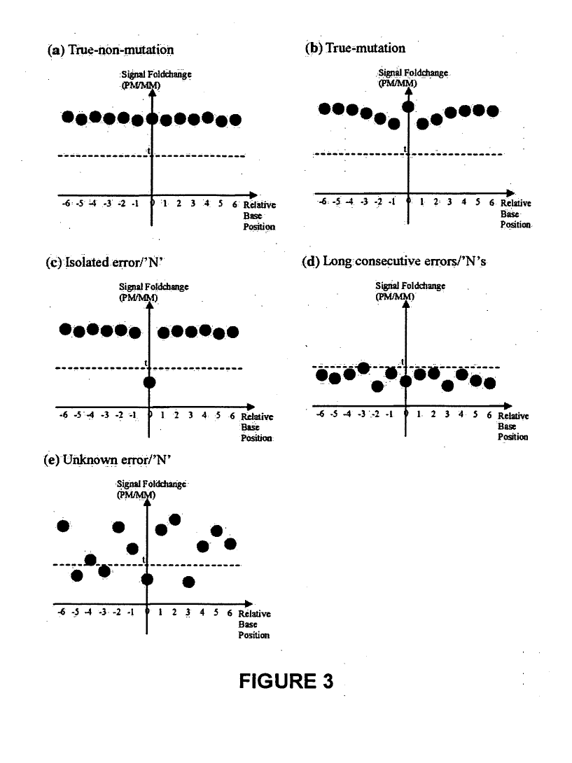

The nature of a suspicious query base is determined by analyzing the hybridization intensities of its PM and MM probes together with its neighbouring (±6 bases from query base) PM and MM probes. Collectively, the hybridization intensities of these probes form a NHIP of the query base. Each query base is analysed to be classified as an isolated error, part of a poor quality region or real sequence variation based on its NHIP. FIG. 3 shows the hybridization intensity patterns (NHIP) that are used to extract information from noisy calls.

NHIP analysis results in a more informative decision on base-calling. Five distinct types of NHIP belonging to true non-mutations (wild-type), true mutations, isolated errors/‘N’s, long consecutive errors/‘N’s, and unknown errors/‘N’s, respectively are present and shown in FIG. 3. For query bases with NHIP shown in FIG. 3(b), the middle base is a mutation. It results in a mismatch in neighbouring PM probes and causes a drop in their hybridization intensities. The closer this mutation is to the center of a neighbouring PM probe, the bigger the drop in hybridization intensity. Thus in FIG. 3(b), detecting a dip in the NHIP of a putative mutagenic query base gives a very strong indication that the mutation is real.

On the other hand, query bases with NHIP shown in FIG. 3(c) do not seem to affect the hybridization intensities of their neighbouring PM probes in any significant way. These query bases are most likely isolated type I errors caused by poor PM probe quality. As such, the base-calls of these query bases are corrected to their respective reference bases in the reference sequences (second known polynucleotide strand).

Query bases with NHIP shown in FIG. 3(d) and FIG. 3(e) are more complex and can occur for several reasons, most notably weak PCR or poor probe quality. In such cases, NHIP analysis alone is unable to recover these query bases. A simple solution would be to make an unknown ‘N’ call for such query bases.

Finally, to confirm the mutation and/or to identify the nucleic acid at the base query, nucleotide substitution bias analysis is carried out on these query bases.

### Example 1

### RNA Isolation and Amplification of Patient Isolates

Viral RNA from diagnostic swabs or RNA extracted from MDCK cell cultures was extracted using the DNA minikit (Qiagen, Inc, Valencia, Calif., USA) according to manufacturer's instructions. RNA was reverse-transcribed to cDNA using customized random primers designed using LOMA (Lee, 2008) and then amplified by PCR using proprietary H1N1 (2009) specific primers. The presence of 2009 influenza A (H1N1) virus in the samples was confirmed using a separate real-time PCR assay based on the published primer sequences from the Centre for Disease Control and Prevention (CDC), USA.

### Design of Probes in Mutation Hotspots

36 mutation hotspots were found in the alignments where mutations occurred near one another (within 20 bp). A perfect match (PM) probe residing in a mutation hotspot may contain mismatches that will have a detrimental effect on its hybridization intensity. To avoid this problem, additional mismatch probes were designed that contain all possible combinations of mutations found in each mutation hotspot. Thus, if two mutations are found within 20 bp of each other in the alignments, then in total four (2²) additional mismatch probes were needed to encode them. In general, 2^{x} additional mismatch probes are needed to completely encode a cluster of x mutations that occur within 20 bp of one another in the alignments.

### Resequencing Array Design

The 2009 Influenza A (H1N1) virus resequencing array was designed based on eight consensus sequences (one for each segment; SEQ ID NO:1-8) derived from 1715 complete and partial sequences of 2009 Influenza A (H1N1) virus isolates deposited in NLM/NCBI H1N1 flu resources database (http://www.ncbi.nlm.nih.gov/genomes/FLU/SwineFlu.html) as of Jun. 11, 2009. Each consensus sequence of a segment was generated by aligning all available sequences of the segment using MAFFT (Koh, 2008) with high accuracy option. At the time of production (June 2009), no deletions, insertions or significant evidence of recombination in the alignments of the eight segments were found. There has also been no reports of any deletions, insertions or recombination in 2009 Influenza A (H1N1) virus sequences deposited in NCBI up to September 2009. This suggests that, at the present stage, mutation is the only evolutionary mechanism driving changes to the 2009 Influenza A (H1N1) virus.

Probes encoding all possible combinations of such mutations (as mentioned in the Design of probes in mutation hotspots section, subject to the maximum probe limit of the array) were included. Lastly, to enhance the usability of the array not only as an evolutionary surveillance tool but also as an evolutionary alarm, genomic sequences of the drug-binding pocket targeted by neuraminidase inhibitors (Maurer-Stroh S, 2009) such as oseltamivir (Tamiflu®) and zanamivir (Relenza®) were included onto the array. In this way, any nucleotide mutations that might cause a change in the amino acids in the drug-binding pocket and consequently render current neuraminidase inhibitors ineffective, will be accurately detected and reported by the array.

The complete list of consensus sequences, mutational hotspots, structural important sites and drug-binding sites of the 2009 Influenza A (H1N1) virus used for the design of the array of the preferred embodiment is given in Table 1. The sequence of the 8 segments of the consensus sequence is in Table, 2. There are 54 sequences of total length 16,861 bases. In order to interrogate both strands of the 54 sequences for all possible single nucleotide substitutions, the array consists of 8×16,861 probes (of variable length 29-39 nucleotides with optimized annealing temperature). There are 4 probes (‘A’, ‘C’, ‘G’ and ‘T’ probes) to interrogate each base of the 54 sequences on each strand. Among these 4 probes, the one that matches exactly to the given sample sequence is known as the perfect match (PM) probe, while the rest are mismatch (MM) probes. The correct base is deduced by analyzing the differences in hybridization signal intensities between sequences that bind strongly to the PM probe and those that bind weakly to the corresponding MM probes. As such, probes are designed such that the location of the interrogated target base is in the centre-most position of the probe, and thus provides the best discrimination for hybridization specificity. The array design ensures that bases that reside in the important regions of the virus are queried at least 4 and up to 8 times each and at least 2 times otherwise, and provides 99.9 percent coverage of the 2009 Influenza A (H1N1) virus (dated June 2009).

TABLE 1
List of sequences on the array.

| | | | | | Drug | |
|---|---|---|---|---|---|---|
| | | | | Mutation | Binding | |
| Sequence On Array | Length | Start | End | Hotspots | Sites | Remarks |
| Consensus Segment1, | 2358 | 1 | 2358 | | | Consensus |
| SEQ ID NO: 1 | | | | | | of 175 |
| | | | | | | sequences |
| Consensus Segment2, | 2334 | 1 | 2334 | | | Consensus |
| SEQ ID NO: 2 | | | | | | of 176 |
| | | | | | | sequences |
| Consensus Segment3, | 2259 | 1 | 2259 | | | Consensus |
| SEQ ID NO: 3 | | | | | | of 164 |
| | | | | | | sequences |
| Consensus Segment4, | 1772 | 1 | 1772 | | | Consensus |
| SEQ ID NO: 4 | | | | | | of 306 |
| | | | | | | sequences |
| Consensus Segment5, | 1576 | 1 | 1576 | | | Consensus |
| SEQ ID NO: 5 | | | | | | of 237 |
| | | | | | | sequences |
| Consensus Segment6, | 1458 | 1 | 1458 | | | Consensus |
| SEQ ID NO: 6 | | | | | | of 226 |
| | | | | | | sequences |
| Consensus Segment7, | 1032 | 1 | 1032 | | | Consensus |
| SEQ ID NO: 7 | | | | | | of 231 |
| | | | | | | sequences |
| Consensus Segment8, | 892 | 1 | 892 | | | Consensus |
| SEQ ID NO: 8 | | | | | | of 200 |
| | | | | | | sequences |
| Segment4:238623307:671:S220T | 53 | 671 | 723 | 696, 698 | | |
| Segment4:229892703:671:S220T | 53 | 671 | 723 | 696, 698 | | |
| Segment5:238867423:321:V100I | 55 | 321 | 375 | 346, 349 | | |
| Segment5:237511907:321:V100I | 55 | 321 | 375 | 346, 350 | | |
| Segment5:227831760:305:V100I | 67 | 305 | 371 | 330, 346 | | |
| Segment5:237651443:321:G:V100I | 57 | 321 | 377 | 346, 352 | | |
| Segment5:237651443:321:A:V100I | 57 | 321 | 377 | 346, 352 | | |
| Segment5:229462688:321:V100I | 57 | 321 | 377 | 346, 352 | | |
| Segment6:238867489:289:V106I | 73 | 289 | 361 | 314, | | |
| | | | | 323, 336 | | |
| Segment6:229396352:287:G:V106I | 74 | 287 | 360 | 312, 335 | | |
| Segment6:229396352:287:A:V106I | 74 | 287 | 360 | 312, 335 | | |
| Segment6:237825455:310:V106I | 53 | 310 | 362 | 335, 336 | | |
| Segment6:229536043:718:N248D | 70 | 718 | 787 | 743, 762 | | |
| Segment6:229535805:715:N248D | 73 | 715 | 787 | 740, 741, | | |
| | | | | 758, 762 | | |
| Segment6:237651385:715:T:N248D | 73 | 715 | 787 | 740, 762 | | |
| Segment6:237651385:715:C:N248D | 73 | 715 | 787 | 740, 762 | | |
| Segment6:229783402:737:N248D | 77 | 737 | 813 | 762, 788 | | |
| Segment8:237780616:352:I123V | 69 | 352 | 420 | 377, 395 | | |
| Segment8:229484056:352:I123V | 69 | 352 | 420 | 377, 395 | | |
| Sequence6:DrugTarget:242 | 270 | 242 | 511 | | 372, 375, | Circulating |
| | | | | | 420, 471, | Subtype: |
| | | | | | 474, 486 | 336 |
| | | | | | | Structural |
| | | | | | | Importance: |
| | | | | | | 426 |
| | | | | | | Multiple |
| | | | | | | Patient |
| | | | | | | Occurrence: |
| | | | | | | 267, 303 |
| Sequence6:DrugTarget:530 | 54 | 530 | 583 | | 555, 558 | |
| Sequence6:DrugTarget:599 | 51 | 599 | 649 | | | Structural |
| | | | | | | Importance: |
| | | | | | | 624 |
| Sequence6:DrugTarget:659 | 138 | 659 | 796 | | 684, | Circulating |
| | | | | | 687, 690, | Subtype: |
| | | | | | 693, 693, | 762 |
| | | | | | 702, 759 | Structural |
| | | | | | | Importance: |
| | | | | | | 747, 750, |
| | | | | | | 753, 771 |
| | | | | | | Multiple |
| | | | | | | Patient |
| | | | | | | Occurrence: |
| | | | | | | 765 |
| Sequence6:DrugTarget:818 | 114 | 818 | 931 | | 843, | Structural |
| | | | | | 849, 852, | Importance: |
| | | | | | 897, 903 | 900, 906 |
| Sequence6:DrugTarget:1028 | 57 | 1028 | 1084 | | 1053, 1056 | Structural |
| | | | | | | Importance: |
| | | | | | | 1059 |
| Sequence6:DrugTarget:1097 | 51 | 1097 | 1147 | | 1122 | |
| Sequence6:DrugTarget:1196 | 54 | 1196 | 1249 | | 1224 | Structural |
| | | | | | | Importance: |
| | | | | | | 1221 |
| Sequence6:DrugTarget:1268 | 51 | 1268 | 1318 | | | Structural |
| | | | | | | Importance: |
| | | | | | | 1293 |
| Sequence6:DrugTarget:1346 | 53 | 1346 | 1398 | | | Multiple |
| | | | | | | Patient |
| | | | | | | Occurrence: |
| | | | | | | 1371 |
| Segment4:237769995:445:A | 71 | 445 | 515 | 470, 490 | | |
| Segment4:227977171:729:GG | 54 | 729 | 782 | 754, 757 | | |
| Segment4:227977171:729:GA | 54 | 729 | 782 | 754, 757 | | |
| Segment4:227977171:729:AG | 54 | 729 | 782 | 754, 757 | | |
| Segment4:227977171:729:AA | 54 | 729 | 782 | 754, 757 | | |
| Segment5:238867371:672 | 71 | 672 | 742 | 697, 717 | | |
| Segment5:238627835:722:CC | 53 | 722 | 774 | 747, 749 | | |
| Segment5:238627835:722:CT | 53 | 722 | 774 | 747, 750 | | |
| Segment5:238627835:722:TC | 53 | 722 | 774 | 747, 751 | | |
| Segment5:238627835:722:TT | 53 | 722 | 774 | 747, 752 | | |
| Segment1:238505743:549 | 52 | 549 | 600 | 574, 575 | | |
| Segment3:238015650:1232 | 57 | 1232 | 1288 | 1257, 1263 | | |
| Segment4:238638050:1228 | 54 | 1228 | 1281 | 1253, 1256 | | |
| Segment4:237651332:1411 | 61 | 1411 | 1471 | 1436, 1446 | | |
| Segment6:229598893:1039 | 54 | 1039 | 1092 | 1064, 1067 | | |
| Segment5:229892751:1140 | 77 | 1140 | 1216 | 1165, | | |
| | | | | 1166, 1191 | | |
| Segment5:237659597:1141 | 76 | 1141 | 1216 | 1166, | | |
| | | | | 1182, 1191 | | |

Locations of mutation hotspots, drug-binding sites, structural important sites and other interesting sites within each sequence are also included. All positions given are with respect to the 8 consensus segments.

TABLE 2
Sequences of the 8 consensus segments of the 2009 Influenza A (H1N1) virus

| SEQ ID NO: | Nucleotide Sequence |
|---|---|
| SEQ ID | tagcaaaagcaggtcaaatatattcaatatggagagaataaaAgaACTGAGAGATCTAATGTCGCAGTCCCGCACTCGCGAGA |
| NO: 1 | TACTCACTAAGACCACTGTGGACCATATGGCCATAATCAAAAAGTACACATCAGGAAGGCAAGAGAAGAAC |
| | CCCGCACTCAGAATGAAGTGGATGATGGCAATGAGATACCCAATTACAGCAGACAAGAGAATAATGGACAT |
| | GATTCCAGAGAGGAATGAACAAGGACAAACCCTCTGGAGCAAAACAAACGATGCTGGATCAGACCGAGTGA |
| | TGGTATCACCTCTGGCCGTAACATGGTGGAATAGGAATGGCCCAACAACAAGTACAGTTCATTACCCTAAG |
| | GTATATAAAACTTATTTCGAAAAGGTCGAAAGGTTGAAACATGGTACCTTCGGCCCTGTCCACTTCAGAAAT |
| | CAAGTTAAAATAAGGAGGAGAGTTGATACAAACCCTGGCCATGCAGATCTCAGTGCCAAGGAGGCACAGGA |
| | TGTGATTATGGAAGTTGTTTTCCCAAATGAAGTGGGGGCAAGAATACTGACATCAGAGTCACAgaGGCAAT |
| | AACAAAaGAGAAGAAAGAAGAGCTCCAGGATTGTAAAATTGCTCCCTTGATGGTGGCGTACATGCTAGAAA |
| | GAGAATTGGTCCGTAAAACAAGGTTTCTCCCAGTAGCCGGCGGAACAGGCAGTGTTTATATTGAAGTGTTG |
| | CACTTAACCCAAGGGACGTGCTGGGAGCAGATGTACACTCCAGGAGGAGAAGTGAGAAATGATGATGTTG |
| | ACCAAAGTTTGATTATCGCTGCTAGAAACATAGTAAGAAGAGCAGCAGTGTCAGCAGACCCATTAGCATCTC |
| | TCTTGGAAATGTGCCACAGCACACAGATTGGAGGAGTAAGGATGGTGGACATCCTTAGACAGAATCCAACT |
| | GAGGAACAAGCCGTAGACATATGCAAGGCAGCAATAGGGTTGAGGATTAGCTCATCTTTCAGTTTTGGTGG |
| | GTTCACTTTCAAAAGGACAAGCGGATCATCAGTCAAGAAAGAAGAAGAAGTGCTAACGGGCAACCTCCAAA |
| | CACTGAAAATAAGAGTACATGAAGGGTATGAAGAATTCACAATGGTTGGGAGAAGAGCAACAGCTATTCTCA |
| | GAAAGGCAACCAGGAGATTGATCCAGTTGATAGTAAGCGGGAGAGACGAGCAGTCAATTGCTGAGGCAAT |
| | AATTGTGGCCATGGTATTCTCACAAGAGGATTGCATGATCAAGGCAGTTAGGGGCGATCTGAACTTTGTCAA |
| | TAGGGCAAACCAGCGACTGAACCCCATGCACCAACTCTTGAGGCATTTCCAAAAAGATGCAAAAGTGCTTTT |
| | CCAGAACTGGGGAATTGAATCCATCGACAATGTGATGGGAATGATCGGAATACTGCCCGACATGACCCCAA |
| | GCACGGAGATGTCGCTGAGAGGGATAAGAGTCAGCAAAATGGGAGTAGATGAATACTCCAGCACGGAGAG |
| | AGTGGTAGTGAGTATTGACCGATTTTTAAGGGTTAGAGATCAAAGAGGGAACGTACTATTGTCTCCCGAAGA |
| | AGTCAGTGAAACGCAAGGAACTGAGAAGTTGACAATAACTTATTCGTCATCAATGATGTGGGAGATCAATGG |
| | CCCTGAGTCAGTGCTAGTCAACACTTATCAATGGATAATCAGGAACTGGGAAATTGTgAAAATTCAATGGTCa |
| | CAAGATCCCACAATGTTATACAACAAAATGGAATTTGAACCATTTCAGTCTCTTGTCCCTAAGGCAACCAGAA |
| | GCCGGTACAGTGGATTCGTAAGGACACTGTTCCAGCAAATGCGGGATGTGCTTGGGACATTTGACACTGTC |
| | CAAATAATAAAACTTCTCCCCTTTGCTGCTGCTCCACCAGAACAGAGTAGGATGCAATTTTCCTCATTGACTG |
| | TGAATGTGAGAGGATCAGGGTTGAGGATACTGGTAAGAGGCAATTCTCCAGTATTCAATTACAACAAGGCA |
| | ACCAAACGACTTACAGTTCTTGGAAAGGATGCAGGTGCATTGACTGAAGATCCAGATGAAGGCACATCTGG |
| | GGTGGAGTCTGCTGTCCTGAGAGGATTTCTCATTTTGGGCAAAGAAGACAAGAGATATGGCCCAGCATTAA |
| | GCATCAATGAACTGAGCAATCTTGCAAaAGGAgAGAAgGCTAATGTGCTAATTGGGCAAGGGGACGTAGTGT |
| | TGGTAATGAAACGAAAACGGGACTCTAGCATACTTACTGACAGCCAGACAGCGACCAAAAGAATTCGGATG |
| | GCCATCAATTAgtgtcgaattgtttaaaaacgaccttgtttctactaggtcatagctgtttc |
| SEQ ID | gcaggcaaaccatttgaatggatgtcaatccgactctacttttcctaaaaattccagcgcaaAATGCCATAAGCACCACATTCC |
| NO: 2 | CTTATACTGGAGATCCTCCATACAGCCATGGAACAGGAACAGGATACACCATGGACACAGTAAACAGAACACACCAATA |
| | CTCAGAAAAGGGAAAGTGGACGACAAACACAGAGACTGGTGCaCCCCAgCTCAACCCGATTGATGGACCAC |
| | TACCTGAGGATAATGAACCAAGTGGGTATGCACAAACAGACTGTGTTCTAGAGGCTATGGCTTTCCTTGAAG |
| | AATCCCACCCAGGAATATTTGAGAATTCATGCCTTGAAACAATGGAAGTTGTTCAACAAACAAGGGTAGATA |
| | AACTAACTCAAGGTCGCCAGACTTATGATTGGACATTAAACAGAAATCAACCGGCAGCAACTGCATTGGCCA |
| | ACACCATAGAAGTCTTTAGATCGAATGGCCTAACAGCTAATGAGTCAGGAAGGCTAATAGATTTCTTAAAGG |
| | ATGTAATGGAATCAATGAACAAAGAGGAAATAGAGATAACAACCCACTTTCAAAGAAAAAGGAGAGTAAGAG |
| | ACAACATGACCAAGAAGATGGTCACGCAAAGAACAATAGGGAAGAAAAAACAAAGACTGAATAAGAGAGGC |
| | TATCTAATAAGAGCACTGACATTAAATACGATGACCAAAGATGCAGAGAGAGGCAAGTTAAAAAGAAGGGCT |
| | ATCGCAACACCTGGGATGCAGATTAGAGGTTTCGTATACTTTGTTGAAACTTTAGCTAGGAGCATTTGCGAA |
| | AAGCTTGAACAGTCTGGGCTCCCAGTAGGGGGCAATGAAAAGAAGGCCAAACTGGCAAATGTTGTGAGAAA |
| | GATGATGACTAATTCACAAGACACAGAGATTTCTTTCACAATCACTGGGGACAACACTAAGTGGAATGAAAA |
| | TCAAAATCCTCGAATGTTCCTGGCGATGATTACATATATCACCAGAAATCAACCCGAGTGGTTCAGAAACAT |
| | CCTGAGCATGGCACCCATAATGTTCTCAAACAAAATGGCAAGACTAGGGAAAGGGTACATGTTCGAGAGTA |
| | AAAGAATGAAGATTCGAACACAAATACCAGCAGAAATGCTAGCAAGCATTGACCTGAAGTACTTCAATGAAT |
| | CAACAAAGAAGAAAATTGAGAAAATAAGGCCTCTTOTAATAGATGGCACAGCATCACTGAGTCCTGGGATGA |
| | TGATGGGCATGTTCAACATGCTAAGTACGGTCTTGGGAGTCTCGATACTGAATCTTGGACAAAAGAAATACA |
| | CCAAGACAATATACTGGTGGGATGGGCTCCAATCATCCGACGATTTTGCTCTCATAGTGAATGCACCAAACC |
| | ATGAGGGAATACAAGCAGGAGTGGACAGATTCTACAGGACCTGCAAGTTAGTGGGAATCAACATGAGCAAA |
| | AAGAAGTCCTATATAAATAAGACAGGGACATTTGAATTCACAAGCTTTTTTTATCGCTATGGATTTGTGGCTA |
| | ATTTTAGCATGGAGCTACCCAGCTTTGGAGTGTCTGGAGTAAATGAATCAGCTGACATGAGTATTGGAGTAA |
| | CAGTGATAAAGAACAACATGATAAACAATGACCTTGGACCTGCAACGGCCCAGATGGCTCTTCAATTGTTCA |
| | TCAAAGACTACAGATACACATATAGGTGCCATAGGGGAGACACACAAATTCAGACGAGAAGATCATTTGAGT |
| | TAAAGAAGCTGTGGGATCAAACCCAATCAAAGGTAGGGCTATTAGTATCAGATGGAGGACCAAACTTATACA |
| | ATATACGGAATCTTCACATTCCTGAAGTCTGCTTAAAATGGGAGCTAATGGATGATGATTATCGGGGAAGAC |
| | TTTGTAATCCCCTGAATCCCTTTGTCAGTCATAAAGAGATTGATTCTGTAAACAATGCTGTGGTAATGCCAGC |
| | CCATGGTCCAGCCAAAAGCATGGAATATGATGCCGTTGCAACTACACATTCCTGGATTCCCAAGAGGAATC |
| | GTTCTATTCTCAACACAAGCCAAAGGGGAATTCTTGAGGATGAACAGATGTACCAGAAGTGCTGCAATCTAT |
| | TCGAGAAATTTTTCCCTAGCAGTTCATATAGGAGACCGGTTGGAATTTCTAGCATGGTGGAGGCCATGGTGT |
| | CTAGGGCCCGGATTGATGCCAGGGTCGACTTCGAGTCTGGACGGATCAAGAAAGAAGAGTTCTCTGAGAT |
| | CATGAAGATCTGTTCCACCATTGaagaactcagacggcaaaaataatgaatttaacttgtccttcatgaaaa |
| | aatgcttgtttctacta |
| SEQ ID | ttagcaaaaagcaggtactgatccaaaatggaagactttgtgcgacaatGCTTCaATCCAATGATCGTCGAGCTTGCGGAAAAG |
| NO: 3 | GCAATGAAAGAATATGGGGAAGATCCGAAAATCGAAACTAACAAGTTTGCTGCAATATGCACACATTTGGAAGT |
| | TTGTTTCATGTATTCGGATTTCCATTTCATCGACGAACGGGGTGAATCAATAATTGTAGAATCTGGTGACCC |
| | GAATGCACTATTGAAGCACCGATTTGAGATAATTGAAGGAAGAGACCGAATCATGGCCTGGACAGTGGTGA |
| | ACAGTATATGTAACACAACAGGGGTAGAGAAGCCTAAATTTCTTCCTGATTTGTATGATTACAAAGAGAACC |
| | GGTTCATTGAAATTGGAGTAACACGGAGGGAAGTCCACATATATTACCTAGAGAAAGCCAACAAAATAAAAT |
| | CTGAGAAGACACACATTCACATCTTTTCATTCACTGGAGAGGAGATGGCCACCAAAGCGGACTACACCCTT |
| | GACGAAGAGAGCAGGGCAAGAATCAAAACTAGGCTTTTCACTATAAGACAAGAAATGGCCAGTAGGAGTCT |
| | ATGGGATTCCTTTCGTCAGTCCGAAAGAGGCGAAGAGACAATTGAAGAAAAATTTGAGATTACAGGAACTAT |
| | GCGCAAGCTTGCCGACCAAAGTCTCCCACCGAACTTCTCCAGCCTTGAAAACTTTAGAGCCTATGTAGATG |
| | GATTCGAGCCGAACGGCTGCATTGAGGGCAAGCTTTCCCAAATGTCAAAAGAAGTGAACGCCAAAATTGAA |
| | CCATTCTTGAGGACGACACCACGCCCCCTCAGATTGCCTGATGGGCCTCTTTGCCATCAGCGGTCAAAGTT |
| | CCTGCTGATGGATGCTCTGAAATTAAGTATTGAAGACCCGAGTCACGAGGGGGAGGGAATACCACTATATG |
| | ATGCAATCAAATGCATGAAGACATTCTTTGGCTGGAAAGAGCCTAACATAGTCAAACCACATGAGAAAGGCA |
| | TAAATCCCAATTACCTCATGGCTTGGAAGCAGGTGCTAGCAGAGCTACAGGACATTGAAAATGAAGAGAAG |
| | ATCCCAAGGACAAAGAACATGAAGAGAACAAGCCAATTGAAGTGGGCACTCGGTGAAAATATGGCACCAGA |
| | AAAAGTAGACTTTGATGACTGCAAAGATGTTGGAGACCTTAAACAGTATGACAGTGATGAGCCAGAGCCCA |
| | GATCTCTAGCAAGCTGGgTCCAAAATGAaTTCAAtAAGGCATGtGAATTGACTGATTCAAGCTGGATAGAACTT |
| | GATGAAATAGGAGAAGATGTTGCCCCGATTGAACATATCGCAAGCATGAGGAGGAACTATTTTACAGCAGA |
| | AGTGTCCCACTGCAGGGCTACTGAATACATAATGAAGGGAGTGTACATAAATACGGCCTTGCTCAATGCATC |
| | CTGTGCAGCCATGGATGACTTTCAGCTGATCCCAATGATAAGCAAATGTAGGACCAAAGAAGGAAGACGGA |
| | AAACAAACCTGTATGGGTTCATTATAAAAGGAAGGTCTCATTTGAGAAATGATACTGATGTGGTGAACTTTGT |
| | AAGTATGGAGTTCTCACTCACTGACCCGAGACTGGAGCCACACAAATGGGAAAAATACTGTGTTCTTGAAAT |
| | AGGAGACATGCTCTTGAGGACTGCGATAGGCCAAGTGTCGAGGCCCATGTTCCTATATGTGAGAACCAATG |
| | GAACCTCCAAGATCAAGATGAAATGGGGCATGGAAATGAGGCGCTGCCTTCTTCAGTCTCTTCAGCAGATT |
| | GAGAGCATGATTGAGGCCGAGTCTTCTGTCAAAGAGAAAGACATGACCAAGGAATTCTTTGAAAACAAATC |
| | GGAAACATGGCCAATCGGAGAGTCACCCAGGGGAGTGGAGGAAGGCTCTATTGGGAAAGTGTGCAGGAC |
| | CTTACTGGCAAAATCTGTATTCAACAGTCTATATGCGTCTCCACAACTTGAGGGGTTTTCGGCTGAATCGAG |
| | AAAATTGCTTCTCATTGTTCAGGCACTTAGGGACAACCTGGAACCTGGAACCTTCGATCTTGGGGGGCTATA |
| | TGAAGCAATCGAGGAGTGCCTGATTAATGATCCCTGGGTTTTGCTTAATGCATCTTGGTTCAACTCCTTCCT |
| | CACACATGCACTGAAGTAGttgtggcaatgctactatttgctatccatactgtccaaaaaGgtaccttattt |
| | ctactgtctactgttttttttcctcgaa |
| SEQ ID | acgactagcaaaagcaggggaaaacaaaagcaacaaaaatgaaGGCAATACTAgTaGTTCTGCTATATACATTTGCAACCGC |
| NO: 4 | AAATGCAGACACATTATGTATAGGTTATCATGCGAACAATTCAACAGACACTGTAGACACAGTACTAGAAAA |
| | GAATGTAACAGTAACACACTCTGTTAACCTTCTAGAAGACAAGCATAACGGGAAACTATGCAAACTAAGAGG |
| | GGTAGCCCCATTGCATTTGGGTAAATGTAACATTGCTGGCTGGATCCTGGGAAATCCAGAGTGTGAATCAC |
| | TCTCCACAGCAAGCTCATGGTCCTACATTGTGGAAACATCTAGTTCAGACAATGGAACGTGTTACCCAGGAG |
| | ATTTCATCGATTATGAGGAGCTAAGAGAGCAATTGAGCTCAGTGTCATCATTTGAAAGGTTTGAGATATTCC |
| | CCAAGACAAGTTCATGGCCCAATCATGAcTCGAACAAAGGTgTAACGGcAGCATGTCCTCATGCTGGAGCAA |
| | AAAGCTTCTACAAAAATTTAATATGGCTAGTTAAAAAAGGAAATTCATACCCAAAGCTCAGCAAATCCTACAT |
| | TAATGATAAAGGGAAAGAAGTCCTCGTGCTATGGGGCATTCACCATCCATCTACTAGTGCTGACCAACAAAG |
| | TCTCTATCAGAATGCAGATgCATATGTTTTTGTGGGGTCATCAAGATACAGCAAGAAGTTCAAGCCGGAAAT |
| | AGCAATAAGaCCcAAAGTGAGGgatCaAGAaGGgAGAATGAACTATTACTGGACACTAGTAGAGCCGGGAGA |
| | CAAAATAACATTCGAAGCAACTGGAAATCTAGTGGTACCGAGATATGCATTCGCAATGGAAAGAAATGCTGG |
| | ATCTGGTATTATCATTTCAGATACACCAGTCCACGATTGCAATACAACTTGTCAGACACCCAAGGGTGCTAT |
| | AAACACCAGCCTCCCATTTCAGAATATACATCCGATCACAATTGGAAAATGTCCAAAATATGTAAAAAGCACA |
| | AAATTGAGACTGGCCACAGGATTGAGGAATGTCCCGTCTATTCAATCTAGAGGCCTATTTGGGGCCATTGC |
| | CGGTTTCATTGAAGGGGGGTGGACAGGGATGGTAGATGGATGGTACGGTTATCACCATCAAAATGAGCAG |
| | GGGTCAGGATATGCAGCCGACCTGAAGAGCACACAGAATGCCATTGACGAGATTACTAACAAAGTAAATTC |
| | TGTTaTTGAAAAGATGAATAcaCAgTTCAcAGCAGTAGGTAAAGAGTTCAACCACCTGGAAAAAAGAATAGAG |
| | AATTTAAATAAAAAAGTTGATGATGGTTTCCTGGACATTTGGACTTACAATGCCGAACTGTTGGTTCTATTGG |
| | AAAATGAAAGAACTTTGGACTACCACGATTCAAATGTGAAGAACTTATATGAAAAGGTaAGAAgCCAGtTAAA |
| | AAACAATGCCAAGGAAATTGGAAACGGCTGCTTTGAATTTTACCACAAATGCGATAACACGTGCATGGAAAG |
| | TGTCAAAAATGGGACTTATGACTACCCAAAATACTCAGAGGAAGCAAAATTAAACAGAGAAGAAATAGATGG |
| | GGTAAAGCTGGAATCAACAAGGATTTACCAGATTTTGGCGATCTATTCAACTGTCGCCAGTTCATTGGTACT |
| | GGTAGTCTCCCTGGGGGCAATCAGTTTCTGGATGTGCTCTAATGGGTCTCTACAGTGTaGaATATGtATTTAA |
| | cattaggatttcagaagcatgagaaaaacactt |
| SEQ ID | ttagcaaaaggtagggtagataatcactcaatgagtgacatcgaagccATGGCGTCTCAAGGCACCAAACGATCATATGAACAA |
| NO: 5 | ATGGAGACTGGTGGGGAGCGCCAGGATGCCACAGAAATCAGAGCATCTGTCGGAAGAATGATTGGTGGAAT |
| | CGGGAGATTCTACATCCAAATGTGCACTGAACTCAAACTCAGTGATTATGATGGACGACTAATCCAGAATAG |
| | CATAACAATAGAGAGGATGGTGCTTTCTGCTTTTGATGAGAGAAGAAATAAATACCTAGAAGAGCATCCCAG |
| | TGCTGGGAAGGACCCTAAGAAAACAGGAGGaCCCATATATAGAAGAaTAgaCgGAAAGTGGaTGAGAGAACT |
| | CATCCTTTATGACAAAGAAGAAATAAGGAGAGTTTGGCGCCAAGCAAACAATGGCGAAGAtGCAACAGCAG |
| | GTCTTACTCATATCATGATTTGGCATTCCAACCTGAATGATGCCACATATCAGAGAACAAGAGCGCTTGTTC |
| | GCACCGGAATGGATCCCAGAATGTGCTCTCTAATGCAAGGTTCAACACTTCCCAGAAGGTCTGGTGCCGCA |
| | GGTGCTGCGGTGAAAGGAGTTGGAACAATAGCAATGGAGTTAATCAGAATGATCAAACGTGGAATCAATGA |
| | CCGAAATTTCTGGAGGGGTGAAAATGGACGAAGGACAAGG9TTGCTTATGAAAGAATGTGcAATATCCTCAA |
| | AGGaAAATTTCAAACAGCtGcCCAGAGGGCAATGATGGATCAAGTAAGAGAAAGTCGAAACCCAGGAAACGC |
| | TGAGATTGAAGACCTCATTTTCCTGGCACGGTCAGCACTCATTCTGAGGGGATCAGTTGCACATAAATCCTG |
| | CCTGCCTGCTTGTGTGTATGGGCTTGCAGTAGCAAGTGGGCATGACTTTGAAAGGGAAGGGTACTCACTGG |
| | TCGGGATAGACCCATTCAAATTACTCCAAAACAGCCAAGTGGTCAGCCTGATGAGACCAAATGAAAACCCA |
| | GCTCACAAGAGTCAATTGGTGTGGATGGCATGCCACTCTGCTGCATTTGAAGATTTAAGAGTATCAAGTTTC |
| | ATAAGAGGAAAGAAAGTGATTCCAAGAGGAAAGCTTTCCACAAGAGGGGTCCAGATTGCTTCAAATGAGAA |
| | TGTGGAAacCATGgaCTCCAAtACcCTGGAACTaAGAAGCAGATACTGGGCCATAAGGACCAGGAGTGGAGG |
| | AAATACCAATCAACAAAAGGCATCCGCAGGCCAGATCAGTGTGCAGCCTACATTCTCAGTGCAGCGGAATC |
| | TCCCTTTTGAAAGAGCAACCGTTATGGCAGCATTCAGCGGGAACAATGAAGGACGGACATCCGACATGCGA |
| | ACAGAAGTTATAAGAATGATGGAAAGTGCAAAGCCAGAAGATTTGTCCTTCCAGGGGCGGGGAGTCTTCGA |
| | GCTCTCGGACGAAAAGGCAACGAACCCGATCGTGCCTTCCTTTGACATGAGTAATGAAGGGTCTTATTTCTT |
| | CGGAGACAATGCAGAGGAGTATGACAGTTGAggaaaaatacccttgtttctactaggtcata |
| SEQ ID | agcaaaagcaggagtttaaaatgaatccaaaccAAAAGATAATAACCATTGGTTCGGTCTGTATGACAATTGGAATGGCTA |
| NO: 6 | ACTTAATATTACAAATTGGAAACATAATCTCAATATGGATTAGCCACTCAATTCAACTTGGGAATCAAAATCA |
| | GATTGAAACATGCAATCAAAGCGTCATTACTTATGAAAACAACACTTGGGTAAATCAGACATATGTTAACATC |
| | AGCAACACCAACTTTGCTGCTGGACAGTCAGTGGTTTCCGTGAAATTAGCGGGCAATTCCTCTCTCTGCCCT |
| | GTTaGTGGATGGgCtATATACAGtAAAGACAACAGtaTAAGAATCGGTTCCAAGGGGGATGTGTTTGTCATAAG |
| | GGAACCATTCATATCATGCTCCCCCTTGGAATGCAGAACCTTCTTCTTGACTCAAGGGGCCTTGCTAAATGA |
| | CAAACATTCCAATGGAACCATTAAAGACAGGAGCCCATATCGAACCCTAATGAGCTGTCCTATTGGTGAAGT |
| | TCCCTCTCCATACAACTCAAGATTTGAGTCAGTCGCTTGGTCAGCAAGTGCTTGTCATGATGGCATCAATTG |
| | GCTAACAATTGGAATTTCTGGCCCAGACAATGGGGCAGTGGCTGTGTTAAAGTACAACGGCATAATAACAG |
| | ACACTATCAAGAGTTGGAGAAACAATATATTGAGAACACAAGAGTCTGAATGTGCATGTGTAAATGGTTCTT |
| | GCTTTACtgTaATGACCGATGGACCaAGTgATGGACAGGCCTCaTACAAgATCTTCAGAATAGAAAAGGGAAA |
| | GATAGTCAAATCAGTCGAAATGAATGCCCCTAATTATCACTATGAGGAATGCTCCTGTTATCCTGATTCTAGT |
| | GAAATCACATGTGTGTGCAGGGATAACTGGCATGGCTCGAATCGACCGTGGGTGTCTTTCAACCAGAATCT |
| | GGAATATCAGATAGGATACATATGCAGTGGGATTTTCGGAGACAATCCACGCCCTAATGATAAGACAGGCA |
| | GTTGTGGTCCAGTATCGTCTAATGGAGCAAATGGAGTAAAAGGaTTtTCATTCAAATACGGCAATGGTGTTTG |
| | GATAGGGAGAACTAAAAGCATTAGTTCAAGAAACGGTTTTGAGATGATTTGGGATCCGAACGGATGGACTG |
| | GGACAGACAATAACTTCTCAATAAAGCAAGATATCGTAGGAATAAATGAGTGGTCAGGATATAGCGGGAGTT |
| | TTGTTCAGCATCCAGAACTAACAGGGCTGGATTGTATAAGACCTTGCTTCTGGGTTGAACTAATCAGAGGGC |
| | GACCCAAAGAGAACACAATCTGGACTAGCGGGAGCAGCATATCCTTTTGTGGTGTAAACAGTGACACTGTG |
| | GGTTGGTCTTGGCCAGACGGTGCTGAGTTGCCATTTACCATTGACAAGTAAtttgttcaaaaaactccttgtttctact |
| SEQ ID | cagggagcaaaagcaggtagatatttaaagATGAGTCTTCTAACCGAGGTCGAAACGTACGTTCTTTCTATCATCCCGTC |
| NO: 7 | AGGCCCCCTCAAAGCCGAGATCGCGCAGAGACTGGAAAGTGTCTTTGCAGGAAAGAACACAGATCTTGAG |
| | GCTCTCATGGAATGGCTAAAGACAAGACCAATCTTGTCACCTCTGACTAAGGGAATTTTAGGATTTGTGTTC |
| | ACGCTCACCGTGCCCAGTGAGCGAGGACTGCAGCGTAGACGCTTTGTCCAAAATGCCCTAAATGGGAATG |
| | GGGACCCGAACAACATGGATAGAGCAGTTAAACTATACAAGAAGCTCAAAAGAGAAATAACGTTCCATGGG |
| | GCCAAGGAGGTGTCACTAAGCTATTCAACTGGTGCACTTGCCAGTTGCATGGGCCTCATATACAACAGGAT |
| | GGGAACAGTGACCACAGAAGcTGCTTTtGGTCTagTGTGTGCCACTTGTGAACAGATTGCTGATTCACAGCAT |
| | CGGTCTCACAGACAGATGGCTACTACCACCAATCCACTAATCAGGCATGAAAACAGAATGGTGCTGGCTAG |
| | CACTACGGCAAAGGCTATGGAACAGATGGCTGGATCGAGTGAACAGGCAGCGGAGGCCATGGAGGTTGCT |
| | AATCAGACTAGGCAGATGGTACATGCAATGAGAACTATTGGGACTCATCCTAGCTCCAGTGCTGGTCTGAA |
| | AGATGACCTTCTTGAAAATTTGCAGGCCTACCAGAAGCGAATGGGAGTGCAGATGCAGCGATTCAAGTGAT |
| | CCTCTCGTCATTGCAGCAAATATCATTGGGATCTTGCACCTGATATTGTGGATTACTGATCGTCTTTTTTTCA |
| | AATGTATTTATCGTCGCTTTAAATACGGTTTGAAAAGAGGGCCttctacggaaggagtgcctgagtccatgagggaagaatatc |
| | aacaggaacagcagaGtgcbgtggatgttgacgatggtcattttgtcaacatagagctagagtaaaaaactaccttgtttctac |
| SEQ ID | ggagcaaaagcagggtgacaaaaacataatggactccaacACCATGTCAAGCTTTCAGGTAGACTGTTTCCTTTGGCATATC |
| NO: 8 | aCGCAAGCGATTTGCAGACAATGGATTGGGTGATGCCCCATTCCTTGATCGGCTCCGCCGAGATCAAAAGTC |
| | CTTAAAAGGAAGAGGCAACACCCTTGGCCTCGATATCGAAACAGCCACTCTTGTTGGGAAACAAATCGTGG |
| | AATGGATCTTGAAAGAGGAATCCAGCGAGACACTTAGAATGACAATTGCATCTGTACCTACTTCGCGCTACC |
| | TTTCTGACATGACCCTCGAGGAAATGTCACGAGACTGGTTCATGCTCATGCCTAGGCAAAAGATAATAGGC |
| | CCTCTTTGCgTGCGATTGGACCAGGCGaTCATGGAAAAGAACATAGTACTGAAAGCGAACTTCAGTGTAATC |
| | TTTAACCGATTAGAGACCTTGATACTACTAAGGGCTTTCACTGAGGAGGGAGCAATAGTTGGAGAAATTTCA |
| | CCATTACCTTCTCTTCCAGGACATACTTATGAGGATGTCAAAAATGCAGTTGGGGTCCTCATCGGAGGACTT |
| | GAATGGAATGGTAACACGGTTCGAGTCTCTGAAAATATACAGAGATTCGCTTGGAGAAACTGTGATGAGAAT |
| | GGGAGACCTTCACTACCTCCAGAGCAGAAATGAAAAGTGGCGAGAGCAATTGGGACAGAAATTTGAGGAAA |
| | TAAGGTGGTTAATTGAAGAAATGCGGCACAGATTGAAAGCGACAGAGAATAGTTTCGAACAAATAACATTTA |
| | TGCAAGCCTTACAACTACTGCTTGAAGTAGAACAAGAGATAAGAGCTTTCTCGTTtcagcttatttaatgataaaaaacac |
| | ccttgtttctact |

### Optimization of RT-PCR Primers and Conditions

Due to the small amount of virus present in samples relative to human or cell-line total RNA, it was necessary to amplify the viral RNA through PCR. A combination of sequence-specific and random PCR approaches using LOMA-optimized primers (Lee, 2008) were used. The addition of random primers ensured complete genome amplification, even if mutations were present at the specific-primer binding sites. PCR conditions were optimized by conducting five duplicate hybridizations of the same virus sample cultured from a patient sample under different PCR conditions. The optimized method was then tested on RNA isolated directly from nasal swabs obtained from the same patient and from virus grown in cell culture. Microarray sequences generated from these replicate experiments were compared with capillary sequencing to estimate sequencing accuracy. Results not shown.

Identification of Base Queries with Suspicion of Type I or II Errors (Step 1)

The array specifies that eight probes (four for the forward strand and four for the reverse strand) were used to query each base. For each probe, the hybridization intensity is given by the mean and standard deviation of the fluorescence intensities of 9 individually scanned pixels associated with the probe on the microarray.

The signal-to-noise ratio (SNR) of a probe is defined as the ratio of the mean to the standard deviation of the intensities of the nine pixels associated with the probe. >95% of all probes had SNR less than T_{SNR} (T_{SNR}=μSNR+2σSNR, where μSNR and σSNR are the mean and standard deviation of SNR of all probes on the array). The remaining 5% of probes with SNR≧T_{SNR} are unreliable.

Base queries with one or more probes with ≧T_{SNR} are analysed further in step 2. All base queries whose PM probe in the forward strand and PM probe in the reverse strand are non-complementary, or have weak PM/MM hybridization intensity differentiation (<1.4-fold) are also passed to step 2.

All putative mutation calls are also passed to step 2 for confirmation. In particular, all high confidence calls resulting in a mutation (different from the corresponding base in the reference sequences used to design the array) were also considered to as a putative type II error. Since mutations may have far-reaching implications in epidemiology studies and drug development against the 2009 Influenza A (H1N1) virus, they were subject to further hybridization intensity analysis in step 2 to confirm the mutation.

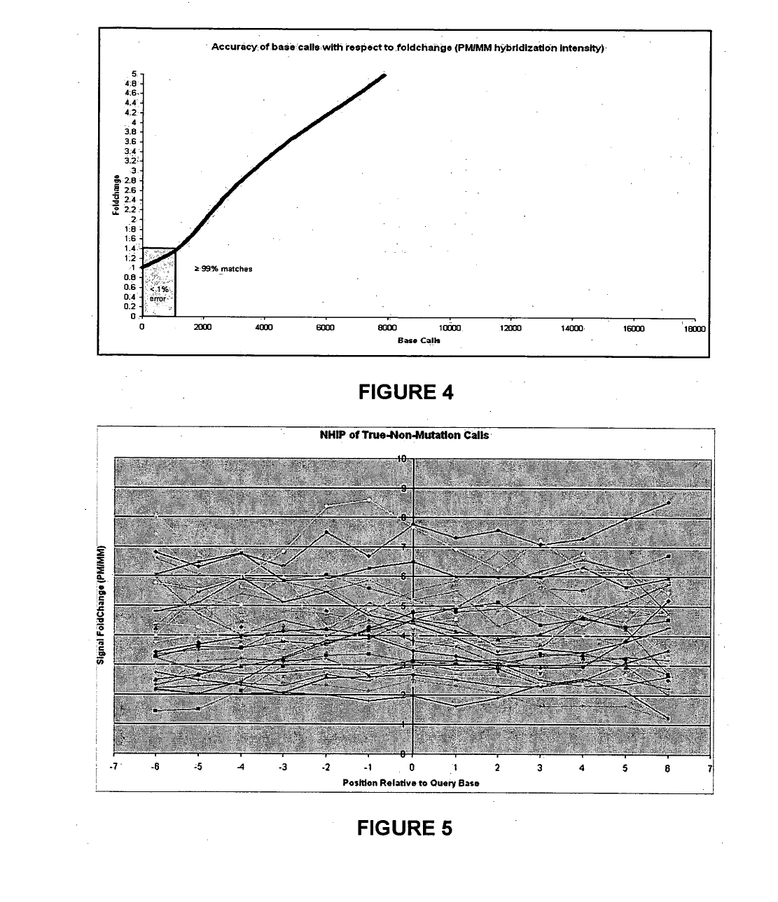

Based on empirical observations, 1.4 was set as the minimum fold-change threshold for PM/MM hybridization intensity since ≧99% of the bases called using this threshold are consistent with capillary and 454 generated sequences from the same sample (FIG. 4). >95% of all probes had T_{SNR} of >1.4. The remaining 5% of probes with unusually low T_{SNR} are the most likely culprits for causing type-I or II errors in a base query.

### Mutation Confirmation and Recovery of Unreliable Query Bases (Step 2)

This step is used to extract any information out of noisy base calls and to determine the validity of a mutation call.

Determination of Neighbourhood Hybridization Intensity Profile (NHIP) Types

Due to the use of tiling probes in re-sequencing arrays, a single nucleotide mutation at a particular query base could cause a dramatic reduction in the hybridization intensities of neighbouring PM probes up to six bases away. This effect can be measured by studying the NHIP of each query base. The NHIP of each query base is defined as the observed pattern of hybridization intensities of its PM and MM probes and neighbouring (±6 bases from query base) PM and MM probes.

FIG. 3 shows the 5 different NHIP types that result from this step. The query base is at position 0 while neighbourhood probes (±6 bases) are numbered according to their distance away from the query base. Dark grey circles represent the PM probe of the query base, and black circles represent neighbourhood PM probes. The five distinct types of NHIP are:
a) True-non-mutation—The PM probe (of both strands) of the query base must be a high-confidence call (i.e. it has hybridization intensity≧1.4-fold that of its mismatch (MM) probes). Neighbourhood PM probes are also high-confidence calls.
   The mean hybridization intensity of the three nearest PM probes to the immediate left of the mutation base (at position −1, −2 and −3), is denoted as μ_{(-1,-2,-3)}, the mean hybridization intensity of the three PM probes to the far left of the mutation base (at position −4, −5 and −6), is denoted as μ_{(-4,-5,-6)}, the mean hybridization intensity of the three nearest PM probes to the immediate right of the mutation base (at position 1, 2 and 3), is denoted as μ_{(1, 2, 3)}, and the mean hybridization intensity of the three PM probes to the far right of the mutation base (at position 4, 5 and 6), is denoted as μ_{(4,5,6)}. It was assumed that μ_{(-1,-2,-3)}≈μ_{(-4,-5,-6)} and μ_{(1,2,3)}≈μ_{(4,5,6)}.
b) True Mutation—The neighbourhood consists of high confidence calls but may have PM probes with lower hybridization intensities compared to the PM probe representing the mutation at the query base. The PM probes (of both strands) of the query base must have hybridization intensity≧1.4 fold that of its MM probes. On average, neighbourhood PM probes have hybridization intensity≧1.4 fold that of their MM probes. Slight dips in hybridization intensities of PM probes closest to the mutation query base may also be observed.
   To detect the characteristic dip, four mean hybridization intensities were checked. If μ_{(-1,-2,-3)}≦μ_{(-4,-5,-6)} and μ_{(1,2,3)}≦μ_{(4,5,6)}. This dip pattern and the query base is likely to be mutated.
c) Isolated error/“N”—Only the query base is noisy, while neighborhood consists of high confidence calls. The PM probe (of either or both strands) of the query base has hybridization intensity<1.4 fold that of its MM probes. On average, neighbourhood PM probes have hybridization intensity≧1.4 fold that of their MM probes. Neighbourhood PM probes are high-confidence calls.
d) Poor quality region/Long consecutive errors/‘N’s—Both the query base and its neighbourhood are noisy. The PM probe (of either or both strands) of the query base has hybridization intensity<1.4 fold that of its MM probes. On average, neighbourhood PM probes have hybridization intensity<1.4 fold that of their MM probes. A majority of neighbourhood PM probes are non-high-confidence calls.
e) Unknown error/“N”—Neighbourhood PM/MM probes do not provide conclusive clues on the nature of the suspicious query base. All other erratic neighbourhood hybridization profile patterns that do not fall under the previous categories.

To study the effects of sequence variation (mutation) and noise on the NHIP of a query base, RNA from H1N1 (2009) patient 380 was sequenced by capillary sequencing and on duplicate microarrays. The sequence calls were compared with those generated using Nimblescan or capillary sequencing and a list of true (correct) calls, error calls and ‘N’ (unknown) calls was compiled.

In total, of the expected 13,588 bases of the H1N1 virus (based on genome described at http://www.ncbi.nlm.nih.gov/genomes/taxg.cgi?tax=211044) the microarray according to a preferred embodiment of the present invention called 13,449 bases while capillary sequence was only able to call 12,832 bases. The microarray according to a preferred embodiment of the present invention is thus more reliable, accurate and efficient.

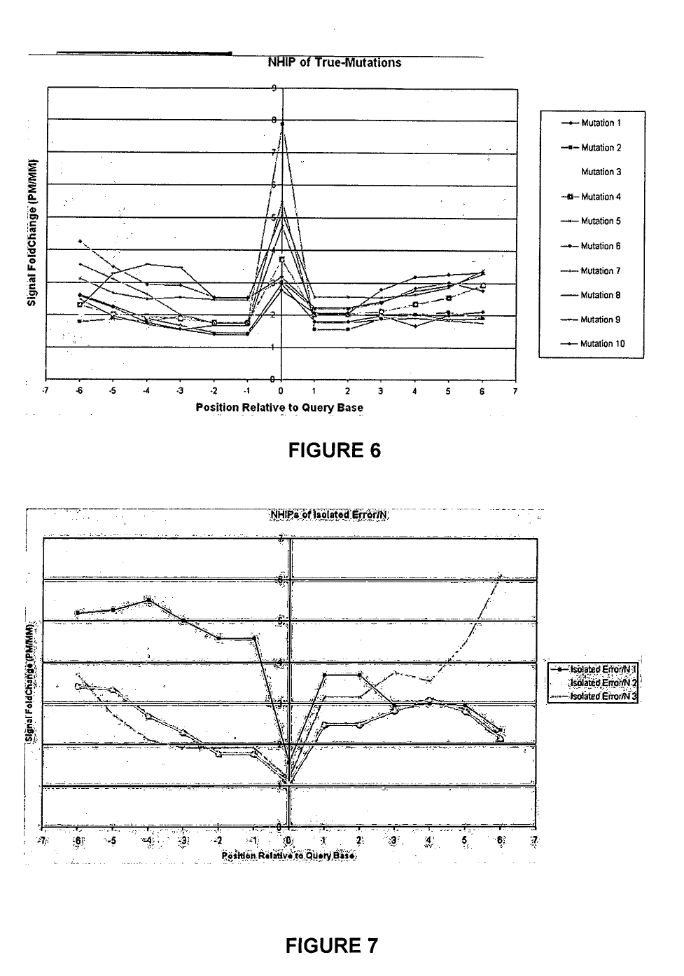

FIG. 5 shows the NHIPs of a representative set of 40 randomly selected query bases that result in true-non-mutation calls (wild-type calls). It was observed that in these NHIPs, the PM probe of the query base together with neighbouring PM probes, have hybridization intensities significantly higher (>1.4-fold) than that of their MM probes in general. 10 mutations were also identified using capillary sequencing in the patient sample. The NHIPs of these 10 true-mutation calls (FIG. 6) are very different from NHIPs of wild-type calls. The presence of a mutation at the query base created an MM in neighbouring PM probes and caused a drop in their hybridization intensities. The closer this mutation is to the centre of a neighbouring PM probe, the bigger the drop in hybridization intensity. This results in a distinctive dip to the immediate left and right of the centre of the NHIP where the mutation is.

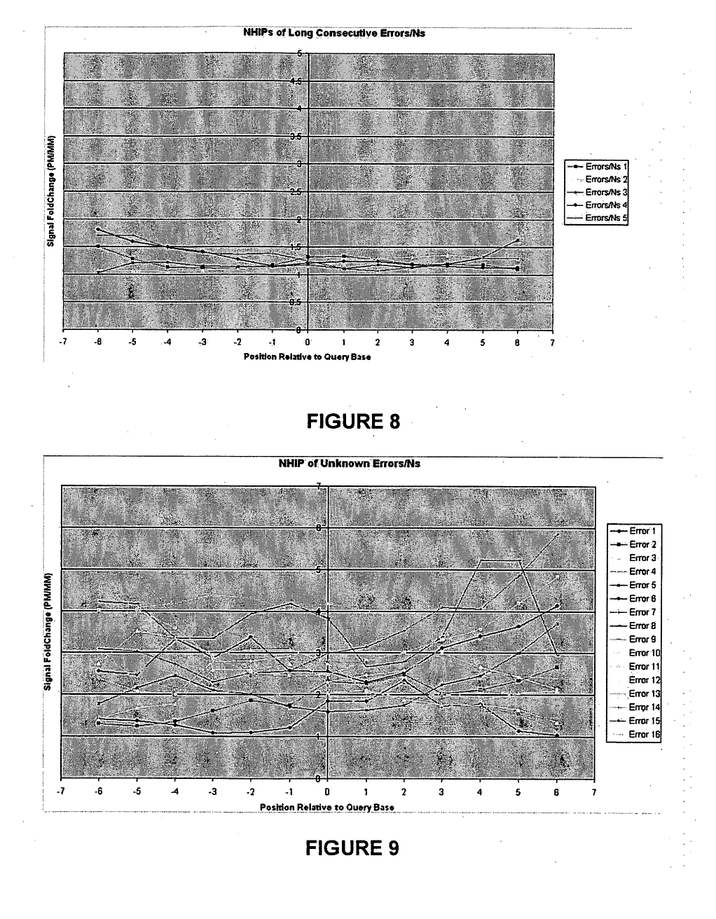

Unlike the NHIPs of wildtype and true-mutation calls, the NHIPs of most errors and ‘N’ calls appear haphazard (FIG. 7). When these errors were traced, the locations of some of these errors and ‘N’ calls on the genome were found to be isolated among good calls while others were conjugated in a small locality of the genome. In NHIPs of isolated errors and ‘N’ calls that occurred among good calls, only the PM probe of the query base that is an error or ‘N’ call has poor hybridization differentiation with its MM probes while other PM probes have hybridization intensities significantly higher than that of their MM probes in general (FIG. 8). This suggests that for such calls, only the PM and MM probes of the query base are noisy while neighbouring PM and MM probes are unaffected.

Long chains of consecutive error and ‘N’ calls (especially at the 50- and 30-end of the sample sequences) often have NHIPs where the PM probe of the query base together with neighbouring PM probes, have poor hybridization differentiation with their MM probes (FIG. 9). These error and ‘N’-calls usually occur at the ends of the genome segments.

NHIP analysis showed that all true mutation calls had a characteristic profile (FIG. 3b) that differed from wild-type sequence calls (FIG. 3a). Ambiguous calls arising from different causes, such as homopolymers, isolated errors and hybridization artifacts also have profiles that are distinct from true mutation profiles (FIG. 3).

Nucleotide Substitution Bias Analysis

Re-sequencing arrays rely on the difference in hybridization intensity between a specific hybridization of a PM probe and non-specific hybridization from its MM probes to make a base-call. However, there is evidence that non-specific binding by MM probes depends upon the individual nucleotide substitutions they incorporate. This nucleotide substitution bias implies that a general order in terms of hybridization intensity reduction may exist among the MM probes of each PM probe such that it is possible to compute the likelihood that an observed PM probe is indeed the true PM probe of the sample sequence given the hybridization intensity-based ordering of its MM probes. The key idea is to build a likelihood model of the substitution bias among the probes of non-ambiguous calls on the array; then use this to call bases with ambiguous signals.

The effects of nucleotide substitutions was determined using PM and MM probes (both strands) from high confidence base calls without suspicion of having type I or II errors. There was clear evidence of nucleotide substitution biases shown. The findings from an experiment (305M_A06) is shown in Table 3.

Regardless of strand,
1. If PM probe encodes ‘A’, then the prevalent order is A→T, A→G, A→C in increasing reduction of hybridization intensities.
2. If PM probe encodes ‘C’, then the prevalent order is C→A, C→/T in increasing reduction of hybridization intensities.
3. If PM probe encodes ‘G’, then the prevalent order is G→A, G→C, G→T in increasing reduction of hybridization intensities.
4. If PM probe encodes ‘T’, then the prevalent order is T→G, T→C, T→A in increasing reduction of hybridization intensities.

TABLE 3
Nucleotide substitution biases found in sample 305M_A06.

| | | Forward strand | | | Reverse strand | | |
|---|---|---|---|---|---|---|---|
| PM | | Frequency | Frequency of | Frequency | Frequency | Frequency of | Frequency |
| probe | MM | of least | intermediate | of most | of least | intermediate | of most |
| encoding | substitution | reduction | reduction | reduction | reduction | reduction | reduction |
| A | C | 552 | 1059 | 3051 | 190 | 481 | 2569 |
| | G | 1392 | 2335 | 935 | 711 | 2089 | 440 |
| | T | 2718 | 1268 | 676 | 2339 | 670 | 231 |
| C | A | 1981 | 486 | 260 | 2840 | 406 | 177 |
| | G | 333 | 1106 | 1288 | 254 | 1334 | 1835 |
| | T | 413 | 1135 | 1179 | 329 | 1683 | 1411 |
| G | A | 1441 | 1248 | 734 | 1036 | 1078 | 613 |
| | C | 1377 | 1173 | 873 | 1275 | 916 | 536 |
| | T | 605 | 1002 | 1816 | 416 | 733 | 1578 |
| T | A | 526 | 1143 | 1571 | 551 | 1454 | 2657 |
| | C | 945 | 1198 | 1097 | 1276 | 2004 | 1382 |
| | G | 1769 | 899 | 572 | 2835 | 1204 | 623 |

For each PM encoding, the frequency of a MM substitution having the least, intermediate or most reduction in hybridization intensity was counted. The trend is the same for MM substitutions in the forward and reverse strands.

From Table 3, there is strong indication that there exist general orders in terms of hybridization intensity reduction for each PM probe encoding. For example, it is expected that the most frequent hybridization intensity reduction order for PM probes encoding an ‘A’ is TGC since 58% of their MM probes with the substitution ‘T’ suffered the least reduction in hybridization intensity, 50% of their MM probes with the substitution ‘G’ suffered intermediate reduction in hybridization intensity and 65% of their MM probes with the substitution ‘C’ suffered the most reduction in hybridization intensity. There are hybridization intensity reduction orders that are observed primarily for certain PM probes encoding. Thus, if characteristic hybridization intensity reduction orders are identified for each PM probe encoding, then it can be used to ascertain the correctness of a PM probe encoding with some statistical confidence.

Using the same experimental dataset as Table 3, Table 4 shows the enumeration of all possible hybridization intensity reduction orders for each PM probe encoding and their respective frequencies. For each hybridization intensity reduction order, the fraction, f_{obs}, that a hybridization intensity reduction order is observed in the PM probe encoding it belongs to and the random fraction, f_{rand}, that the particular hybridization intensity reduction order is seen in other PM probe encodings was computed. Formally, given a PM probe encoding b₁ and a hybridization intensity reduction order b₂b₃b₄ where b₂, b₃, b₄≠b₁ and b₂ has the least reduction in hybridization while b₄ has the most reduction in hybridization, then

$${f}_{obs} = \frac{\# ( {b}_{1} {b}_{2} {b}_{3} {b}_{4} )}{\begin{matrix}\# ( {b}_{1} {b}_{2} {b}_{3} {b}_{4} ) + \# ( {b}_{1} {b}_{2} {b}_{4} {b}_{3} ) + \# ( {b}_{1} {b}_{3} {b}_{2} {b}_{4} ) + \\ \# ( {b}_{1} {b}_{3} {b}_{4} {b}_{2} ) + \# ( {b}_{1} {b}_{4} {b}_{2} {b}_{3} ) + \# ( {b}_{1} {b}_{4} {b}_{3} {b}_{2} )\end{matrix}}$$

$$and$$

$${f}_{rand} = \frac{\# ( {b}_{1} {b}_{2} )}{t} \times \frac{\# ( {b}_{2} {b}_{3} )}{t} \times \frac{\# ( {b}_{3} {b}_{4} )}{t}$$

where t is the total number of hybridization intensity reduction orders excluding b₁b₂b₃b₄ obtained from high confidence base calls. Finally, the likelihood that an observed PM probe is indeed the true PM probe of the sample sequence given the hybridization intensity-based ordering of its MM probes is estimated by f_{obs}/f_{rand}. Hybridization intensity reduction orders with likelihood scores>2 are statistically significant and are used to discern the PM probe encoding.

TABLE 4
Frequencies of all possible hybridization intensity reduction orders for each PM
probe encoding in sample 305_A06. Hybridization intensity reduction orders that are
significant (likelihood score > 2) and can be used to identify the PM probe encoding are
highlighted.

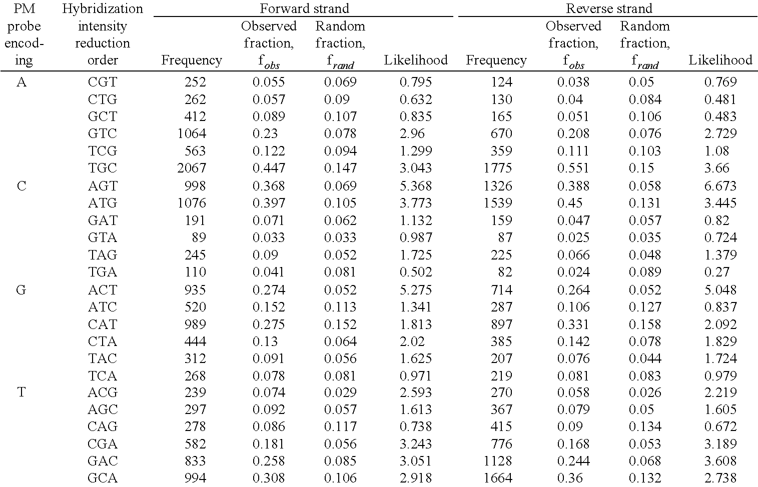

For each of the query bases with NHIP of type described in FIG. 3b, the likelihood l that the observed PM probe (representing the mutation) is indeed the true PM probe of the sample sequence given the hybridization intensity-based ordering of its MM probes was calculated. If l>2, the query base results in a strong mutation call (represented by upper case base calls ‘A’, ‘C’, ‘G’ or ‘T’). If l>1, the query base results in a mutation call with weak support (represented by lower case base calls ‘a’, ‘c’, ‘g’ or ‘t’). Otherwise, they are re-assigned an unknown ‘N’ call.

For query bases that results in a mutation call but have NHIP of type described in FIG. 4c, they are most likely isolated errors caused by poor PM probe quality. The base-calls of these query bases are corrected to their respective reference bases (but represented by lower case base calls ‘a’, ‘c’, ‘g’ or ‘t’) in the reference sequences. The same correction to non-high-confidence query bases with NHIP of type described in FIG. 4c was also performed.

The remaining query bases that have NHIP of type described in FIG. 4d or 4e were recovered by analysing the substitution bias from their PM and MM probes in the forward and reverse strands separately. Similar to how a mutation is confirmed, the likelihood l_{f} that the observed PM probe (representing the unsure base call) is indeed the true PM probe of the sample sequence given the hybridization intensity-based ordering of its MM probes in the forward strand is calculated. A similar likelihood lᵣ for the PM probe in the reverse strand is computed. If the PM probes in both strands are complementary and l_{f}, lᵣ>2, the query base results in a strong base call (represented by upper case base calls ‘A’, ‘C’, ‘G’ or ‘T’). In many cases, the PM probes in both strands are not complementary due to non-specific hybridization of MM probes in one or both strands. For such query bases, base calls are made based on l_{f} and lᵣ: if l_{f}>lᵣ and l_{f}>2, a base call with, weak support (represented by lower case base calls ‘a’, ‘c’, ‘g’ or ‘t’) is made from the PM probe in the forward strand. Else, if lᵣ>l_{f} and l_{f}>2, a base call with weak support is made from the PM probe in the reverse strand. Otherwise, they are assigned an unknown ‘N’ call.

Since nucleotide substitution biases may vary depending on the experimental conditions, experimental reagents or input samples, for each experiment, a set of high-confidence base-calls are obtained and used to infer the hybridization intensity reduction orders for each PM probe encoding. This is then used to compute likelihood “l” scores for base-calling non-high-confidence query bases and mutation confirmation.

The substitution bias on this platform was determined by comparing the PM and MM probes (of both strands) of 25,028 true calls made by PBC from two replicate microarray experiments of patient sample 380. For each true call, a hybridization intensity reduction order was generated by ranking the PM and MM probes of a particular strand in decreasing order of hybridization intensity and recording their respective frequencies (Table 5). Table 5 shows that for each PM probe encoding, certain hybridization intensity reduction orders occur much more frequently than others. For example, if the PM probe encoding is ‘A’ (regardless of strand), then it is most likely that the hybridization intensity reduction order is ‘TGC’ or ‘GTC’. Thus, by matching the hybridization intensity reduction orders of its PM/MM probes with that in Table 5, the likelihood that the putative base call for a query base was determined. In this way, base calls of ambiguous query bases exceeding a reasonably high likelihood threshold and achieve better accuracy and call rate than PBC was recovered.

TABLE 5
Hybridization intensity reduction orders found in two replicated
hybridization experiments of patient sample 380.

| | Hybridization | | |
|---|---|---|---|
| PM probe | intensity | Forward | |
| encoding | reduction | strand | Reverse |
| Frequency | order | Frequency | strand |
| A | CGT | 547 | 246 |
| | CTG | 558 | 237 |
| | GCT | 957 | 367 |
| | GTC | 2215 | 1407 |
| | TCG | 1049 | 611 |
| | TGC | 3015 | 2873 |
| C | AGT | 2035 | 2712 |
| | ATG | 1752 | 2400 |
| | GAT | 382 | 341 |
| | GTA | 159 | 134 |
| | TAG | 360 | 377 |
| | TGA | 165 | 129 |
| G | ACT | 1474 | 1043 |
| | ATC | 976 | 624 |
| | CAT | 1639 | 1534 |
| | CTA | 868 | 788 |
| | TAC | 594 | 410 |
| | TCA | 542 | 454 |
| T | ACG | 432 | 529 |
| | AGC | 562 | 636 |
| | CAG | 623 | 841 |
| | CGA | 1066 | 1616 |
| | GAC | 1421 | 1878 |
| | GCA | 1637 | 2841 |

### Graphical Visualization of Sequence Calls

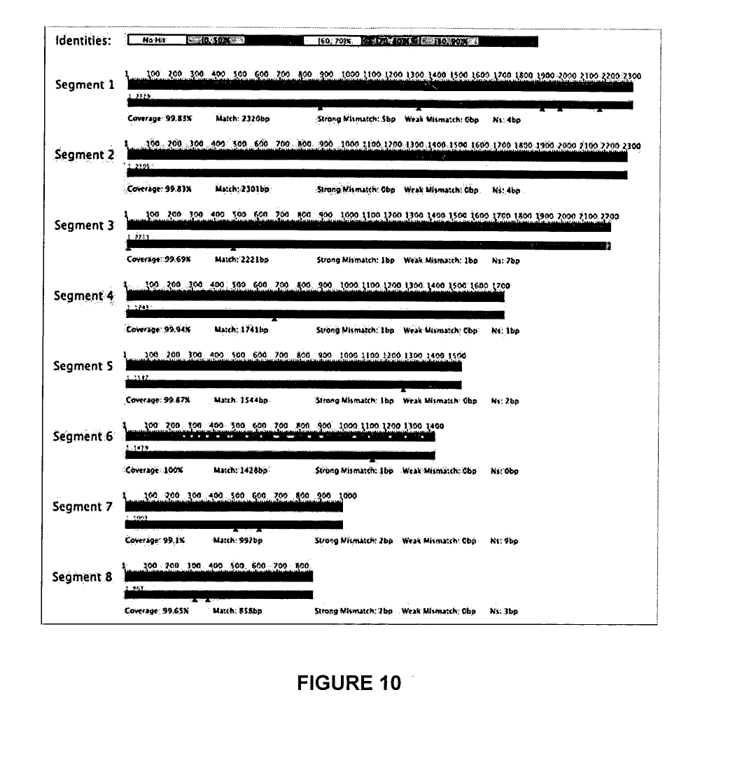

FIG. 10 is a graphical visualization of the sequence calls generated using evoISTAR made in SVG and PDF formats. The locations of mutations detected during the sequence calling and all known drug-binding sites are marked by dark grey/light grey triangles and white circles respectively. In this way, researchers would be able to identify mutations, especially those in close proximity to drug binding sites, at a glance. Other details such as coverage, number of base calls successfully made, number of mutations and number of ‘N’ calls are also shown in the graphical visualization.

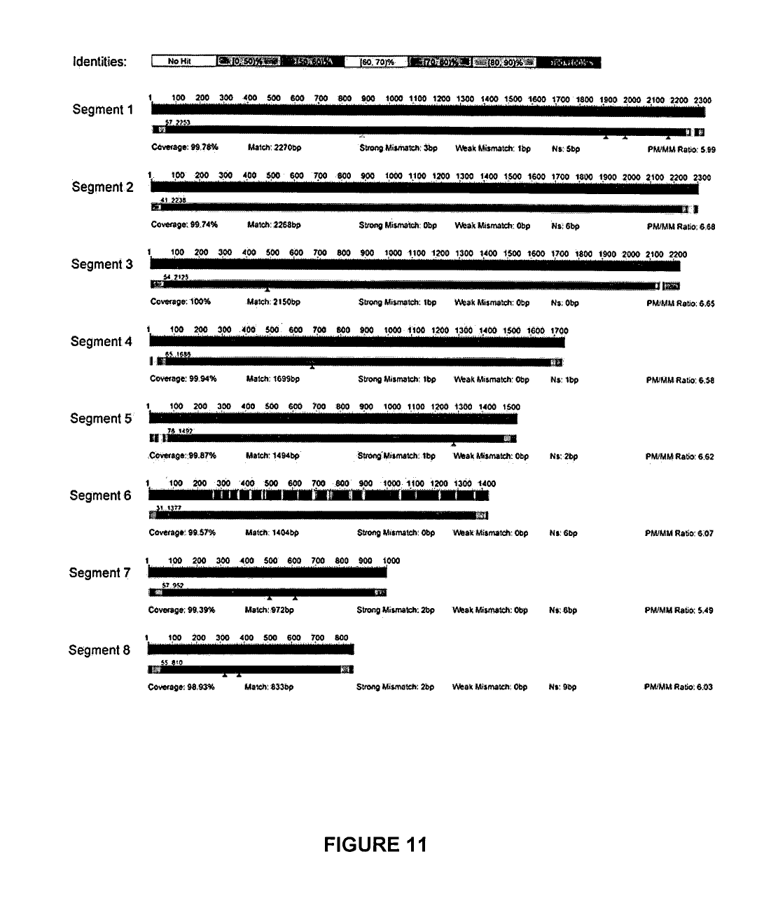

Another heat map based on the percentage identity of the call sequence to the reference sequence measured at 50 bp windows generated from EvoISTAR is shown in FIG. 11.

The map template consists of all eight segments of the 2009 influenza A(H1N1) virus and the locations of known drug binding sites (marked with grey lines) on the NA gene. Locations of all mutation calls are denoted by dark grey triangles beneath the heat map bar. Sequences that are of low coverage (<90%) are automatically flagged, and the overall PM/MM discrimination ratio for each segment is displayed. The heat map bar allows the technician to rapidly assess the quality of the sequence data obtained from the microarray and identify regions where PCR did not work well, or presence of potential recombination/reassortment events. Other details such as coverage, number of base calls successfully made, number of mutations and number of ‘N’ calls for each sequence call are also shown on the visualization map.

### Example 2

### Comparative Study

Six pairs of replicate experiments consisting of one pair of nasal swab (305 A01, 305_A02) and five pairs of cell culture isolates (305_A03, 305_A04; 305_A05, 305_A06; 305A07, 305_A08; 305_A09, 305_A10; 305_A11, 305_A12), belonging to the same patient sample (305) were employed, to determine the robustness of EvoISTAR sequence calls. Of the experiments, two pairs of replicates (305_nasal and 305_cell_cond1) were amplified under the same optimal experimental conditions while each of the other pairs (305_cell_cond2, 305_cell_cond3, 305_cell_cond4, 305_cell_cond5) were amplified under different sub-optimal experimental conditions (simulating experimental volatility). The results were compared with that of the propriety Probabilistic Base Caller (PBC) algorithm used by Nimblegen. This results are shown in Table 6.

On average, EvoISTAR was successful in calling 99.6% of the 13,449 sites of the 2009 Influenza A(H1N1) virus in the six pairs of replicates. Among the sites EvoISTAR called in each pairs of replicates, >99.9% of sites are called identically. In total, there are 10 mutations (compared to the reference sequences) in the genomic sequences of the 2009 Influenza A (H1N1) virus in patient sample 305 and all of them were correctly called by EvoISTAR in each experiment. The error rate was 6.22e-06 (i.e. 1 error in 1,60,750 bases called) since only one base was wrongly called by EvoISTAR in all 12 replicate experiments. By comparison, PBC was successful in calling only 94.3% of the total possible sites. Although PBC managed to correctly call all 10 mutations present in sample 305, it has a relatively high error rate of 0.006 (i.e. 1 error in 165 bases called). In particular, PBC performed badly on nasal swab replicates 305_A01 and 305A02, achieving only up to 86% coverage and >1.5% error rate. There may have been two likely causes: (1) nasal swab samples have much less concentration of virus RNA than cell cultures, and (2) abundance of human DNA in the nasal swab samples. In comparison, EvoISTAR suffered only a slight drop in performance 98.9% coverage) when analyzing these nasal swab samples.

TABLE 6
The call results of EvolSTAR and PBC on 12 replicates of patient sample 305.

| | | | | | | | Real mutations |
|---|---|---|---|---|---|---|---|
| Sample | Algorithm | Total sites | Calls made | ‘N’ calls | Correct calls | Wrong calls | called correctly |
| 305_A01 | EvoSTAR | 13449 | 13317 | 132 | 13317 | 0 | 10 |
| | PBC | 13449 | 11582 | 1867 | 11407 | 175 | 10 |
| 305_A02 | EvoSTAR | 13449 | 13287 | 162 | 13286 | 1 | 10 |
| | PBC | 13449 | 11427 | 2022 | 11208 | 219 | 10 |
| 305_A03 | EvoSTAR | 13449 | 13402 | 47 | 13402 | 0 | 10 |
| | PBC | 13449 | 12803 | 646 | 12735 | 68 | 10 |
| 305_A04 | EvoSTAR | 13449 | 13390 | 59 | 13390 | 0 | 10 |
| | PBC | 13449 | 12672 | 777 | 12591 | 81 | 10 |
| 305_A05 | EvoSTAR | 13449 | 13426 | 23 | 13426 | 0 | 10 |
| | PBC | 13449 | 13009 | 440 | 12971 | 38 | 10 |
| 305_A06 | EvoSTAR | 13449 | 13428 | 21 | 13428 | 0 | 10 |
| | PBC | 13449 | 12989 | 460 | 12955 | 34 | 10 |
| 305_A07 | EvoSTAR | 13449 | 13416 | 33 | 13416 | 0 | 10 |
| | PBC | 13449 | 12957 | 492 | 12905 | 52 | 10 |
| 305_A08 | EvoSTAR | 13449 | 13400 | 49 | 13400 | 0 | 10 |
| | PBC | 13449 | 12806 | 643 | 12729 | 77 | 10 |
| 305_A09 | EvoSTAR | 13449 | 13429 | 20 | 13429 | 0 | 10 |
| | PBC | 13449 | 13060 | 389 | 13017 | 43 | 10 |
| 305_A10 | EvoSTAR | 13449 | 13429 | 20 | 13429 | 0 | 10 |
| | PBC | 13449 | 13024 | 425 | 12992 | 32 | 10 |
| 305_A11 | EvoSTAR | 13449 | 13406 | 43 | 13406 | 0 | 10 |
| | PBC | 13449 | 13028 | 421 | 12978 | 50 | 10 |
| 305_A12 | EvoSTAR | 13449 | 13420 | 29 | 13420 | 0 | 10 |
| | PBC | 13449 | 12923 | 526 | 12871 | 52 | 10 |

EvolSTAR significantly outperformed PBC in terms of coverage and accuracy for all replicates.

The comparison was repeated and it was shown that compared with the available capillary sequences for sample 305, EvoISTAR had an average error rate of 0.0012% and 28 ambiguous calls per sample (338 in total). On the other hand, Nimblescan PBC obtained a relatively higher average error rate of 0.169% and 237 ambiguous calls per sample (2855 in total). EvoISTAR is thusrobust and performs well when samples are prepared under sub-optimal conditions. Even for nasal swab samples that tend to have much less concentration of virus RNA than cell cultures, EvoISTAR suffered only a slight drop in performance compared to Nimblescan PBC.

To further validate the software, 14 patient samples were hybridized in duplicate onto the microarray. The microarrays were analysed in parallel using Nimblescan (PBC algorithm) and EvoISTAR, and the sequences obtained were compared to Sanger capillary sequencing. The number of true-non-mutation calls, true-mutation calls, error calls and ambiguous (‘N’) calls were counted for both methods. The substitution bias was also confirmed in all 14 duplicate hybridization experiments (Table 7) to be consistent with that found in Table 5. Compared with the available capillary sequences for the 14 samples, EvoISTAR had an average error rate of 0.0029% and 12 ambiguous calls per sample (346 in total). This is far superior to Nimblescan PBC, where had an average error rate of 0.083% and 158 ambiguous calls per sample (4,434 in total). EvoISTAR also called all true mutations correctly. The genome coverage attained by EvoISTAR (99.02±0.82%) was also much higher than that of Nimblegen PBC (94.3±6.06%).

TABLE 7
Comparison of calls made by EvolSTAR and PBC for 14 samples

| | | | Total sites | Mutations | True-non- | True | | |
|---|---|---|---|---|---|---|---|---|
| | | | verified by | (verified by | mutation | mutation | Missed | Error |
| Sample | Program | Rep. | capillary | capillary) | calls | calls | mutations | calls |
| 129 | EvolSTAR | 1 | 4767 | 6 | 4737 | 6 | 0 | 0 |
| | PBC | 1 | 4767 | 6 | 4500 | 6 | 0 | 3 |
| | EvolSTAR | 2 | 4767 | 6 | 4737 | 6 | 0 | 0 |
| | PBC | 2 | 4767 | 6 | 4474 | 6 | 0 | 6 |
| 141 | EvolSTAR | 1 | 4051 | 6 | 4026 | 6 | 0 | 0 |
| | PBC | 1 | 4051 | 6 | 3832 | 6 | 0 | 10 |
| | EvolSTAR | 2 | 4051 | 6 | 4021 | 6 | 0 | 0 |
| | PBC | 2 | 4051 | 6 | 3808 | 6 | 0 | 4 |
| 279 | EvolSTAR | 1 | 693 | 2 | 670 | 2 | 0 | 0 |
| | PBC | 1 | 693 | 2 | 358 | 1 | 1 | 8 |
| | EvolSTAR | 2 | 693 | 2 | 682 | 2 | 0 | 0 |
| | PBC | 2 | 693 | 2 | 645 | 2 | 0 | 0 |
| 354 | EvolSTAR | 1 | 8950 | 9 | 8942 | 9 | 0 | 0 |
| | PBC | 1 | 8950 | 9 | 8802 | 9 | 0 | 1 |
| | EvolSTAR | 2 | 8950 | 9 | 8944 | 9 | 0 | 0 |
| | PBC | 2 | 8950 | 9 | 8851 | 9 | 0 | 0 |
| 380 | EvolSTAR | 1 | 12832 | 10 | 12803 | 10 | 0 | 0 |
| | PBC | 1 | 12832 | 10 | 12466 | 10 | 0 | 6 |
| | EvolSTAR | 2 | 12832 | 10 | 12816 | 10 | 0 | 0 |
| | PBC | 2 | 12832 | 10 | 12542 | 10 | 0 | 4 |
| 384 | EvolSTAR | 1 | 6002 | 6 | 5992 | 6 | 0 | 0 |
| | PBC | 1 | 6002 | 6 | 5888 | 6 | 0 | 0 |
| | EvolSTAR | 2 | 6002 | 6 | 5993 | 6 | 0 | 0 |
| | PBC | 2 | 6002 | 6 | 5895 | 6 | 0 | 1 |
| 507 | EvolSTAR | 1 | 3921 | 8 | 3913 | 8 | 0 | 0 |
| | PBC | 1 | 3921 | 8 | 3736 | 8 | 0 | 3 |
| | EvolSTAR | 2 | 3921 | 8 | 3916 | 8 | 0 | 0 |
| | PBC | 2 | 3921 | 8 | 3758 | 8 | 0 | 2 |
| 581 | EvolSTAR | 1 | 8574 | 10 | 8567 | 10 | 0 | 0 |
| | PBC | 1 | 8574 | 10 | 8458 | 10 | 0 | 2 |
| | EvolSTAR | 2 | 8574 | 10 | 8566 | 10 | 0 | 0 |
| | PBC | 2 | 8574 | 10 | 8461 | 10 | 0 | 5 |
| 582 | EvolSTAR | 1 | 3057 | 4 | 3051 | 4 | 0 | 0 |
| | PBC | 1 | 3057 | 4 | 2986 | 4 | 0 | 0 |
| | EvolSTAR | 2 | 3057 | 4 | 3053 | 4 | 0 | 0 |
| | PBC | 2 | 3057 | 4 | 3001 | 4 | 0 | 0 |
| 593 | EvolSTAR | 1 | 3054 | 3 | 3053 | 3 | 0 | 0 |
| | PBC | 1 | 3054 | 3 | 3007 | 2 | 1 | 0 |
| | EvolSTAR | 2 | 3054 | 3 | 3053 | 3 | 0 | 0 |
| | PBC | 2 | 3054 | 3 | 2992 | 2 | 1 | 0 |
| 9061 364 | EvolSTAR | 1 | 5129 | 5 | 5123 | 5 | 0 | 0 |
| | PBC | 1 | 5129 | 5 | 5064 | 5 | 0 | 0 |
| | EvolSTAR | 2 | 5129 | 5 | 5122 | 5 | 0 | 0 |
| | PBC | 2 | 5129 | 5 | 5042 | 5 | 0 | 0 |
| 9061 365 | EvolSTAR | 1 | 3000 | 3 | 2993 | 3 | 0 | 0 |
| | PBC | 1 | 3000 | 3 | 2956 | 3 | 0 | 1 |
| | EvolSTAR | 2 | 3000 | 3 | 2991 | 3 | 0 | 0 |
| | PBC | 2 | 3000 | 3 | 2941 | 3 | 0 | 0 |
| 9061 366 | EvolSTAR | 1 | 1683 | 3 | 1683 | 3 | 0 | 0 |
| | PBC | 1 | 1683 | 3 | 1649 | 3 | 0 | 1 |
| | EvolSTAR | 2 | 1683 | 3 | 1682 | 3 | 0 | 1 |
| | PBC | 2 | 1683 | 3 | 1636 | 3 | 0 | 1 |
| 923 | EvolSTAR | 1 | 4373 | 5 | 4365 | 5 | 0 | 0 |
| | PBC | 1 | 4373 | 5 | 4187 | 5 | 0 | 1 |
| | EvolSTAR | 2 | 4373 | 5 | 4330 | 5 | 0 | 1 |
| | PBC | 2 | 4373 | 5 | 3738 | 5 | 0 | 6 |

More than 70% of the 65 error calls (false mutation calls) made by PBC did not have the characteristic NHIP of a true-mutation shown in FIG. 3b. The remaining 30% of the error calls had a NHIP reminiscent of a true-mutation NHIP but did not satisfy the substitution bias rule. Using NHIP and substitution biases analysis together, the number of false mutation calls were reduced to only two. Most of the 4,434 ‘N’ calls made by PBC were due to conflicting base calls from the forward and reverse strand. By analysing the NHIP and hybridization intensity reduction order of the query base in the forward and reverse strand individually, the noisy strand was identified and hence, the base call only from the non-noisy strand was made. 92% of the ‘N’ calls made by PBC was recovered using this approach.

### Example 3

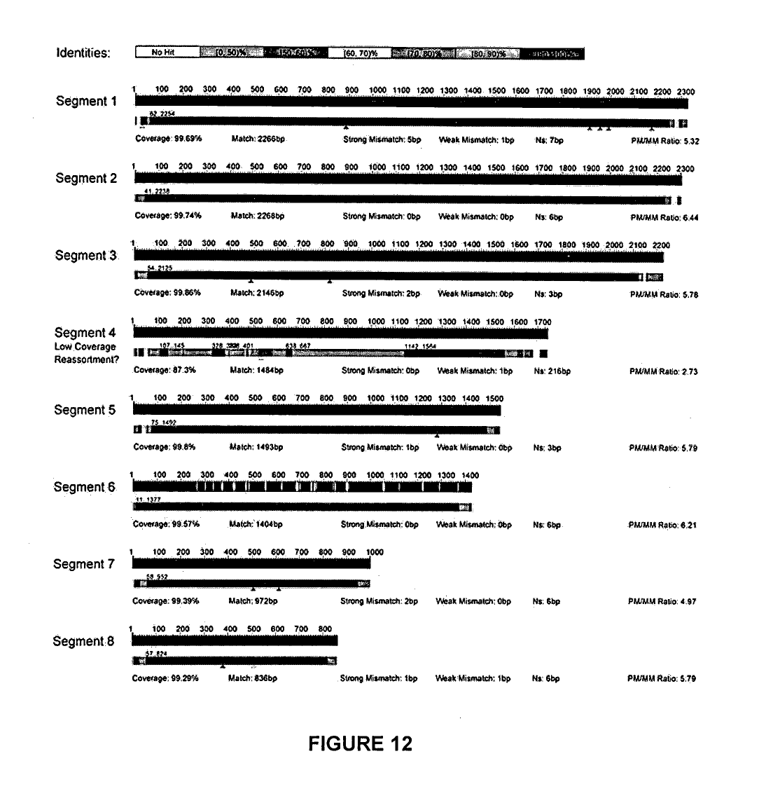

To investigate the effects of a re-assortment event on the array, independently amplified segments 1, 2, 3, 5, 6 and 7 of the 2009 influenza A(H1N1) virus and segment 4 of a H3N2 influenza A virus, were hybridized onto an array according to the preferred embodiment of the present invention. The visualization map of this experiment is shown in FIG. 12.

The sequence call for segment 4 [based on PM/MM probes from the segment 4 consensus of the 2009 influenza A(H1N1) virus] is poor in quality and coverage. Good base calls from region 1150-1547 was obtained. This region turns out to be the only significantly similar (70% matched) region between the segment 4 (SEQ ID NO:4) consensus of the 2009 influenza A(H1N1) virus and segment 4 of a H3N2 virus (CY039087). This shows that identifying regions of high similarity between the 2009 influenza A(H1N1) virus with other influenza viruses and checking if these regions have good sequence calls may be a plausible way of detecting re-assortments.

### REFERENCES

1. Lee, W. H., Wong, C. W., Leong, W. Y., Miller, L. D. and Sung, W. K. (2008) LOMA: a fast method to generate efficient tagged-random primers despite amplification bias of random PCR on pathogens. BMC Bioinformatics, 9, 368.
2. Toh, K. (2008) Recent developments in the MAFFT multiple sequence alignment program. Brief. Bioinformatics, 9, 286-298.
3. Maurer-Stroh, S., Ma, J., Lee, R. T., Sirota, F. L. and Eisenhaber, F. (2009) Mapping the sequence mutations of the 2009 H1N1 influenza k virus neuraminidase relative to drug and antibody binding sites. Biol. Direct., 4, 18; discussion 18.

1. A method of sequencing a first polynucleotide strand having a first polynucleotide sequence, the first polynucleotide strand resembling a second polynucleotide strand having a known second polynucleotide sequence, the method employing a data set which, for one or more fragment(s) of the second polynucleotide sequence, contains:
for each position along each said fragment:
(i) first probe data describing the hybridization intensity of the first polynucleotide strand with a respective first probe designed to bind to a portion of the second polynucleotide strand centered at said position; and
(ii) second probe data describing the respective hybridization intensities of the first polynucleotide strand with each of a set of second probes, each said second probe being designed to bind with a respective mutation of the corresponding portion of the second polynucleotide sequence which is formed by mutating the corresponding portion of the second polynucleotide sequence at said position, the data set including said second probe data for every possible said mutation;
the method comprising:
for each said position, obtaining from the dataset a first numerical parameter characterizing the hybridization intensity of the first polynucleotide strand with a corresponding first probe in comparison to the hybridization intensities of the first polynucleotide strand with the corresponding second probes;
said first numerical parameter being indicative of whether a nucleic acid of the first polynucleotide sequence is equal to a nucleic acid of the second polynucleotide sequence at said position
wherein the method further comprises, at each said position,
obtaining at least one corresponding second numerical parameter indicative of data abnormalities in the first probe data and second probe data relating to said position;
determining whether:
(i) said first numerical parameter indicates that the nucleic acid of the first polynucleotide sequence is equal to the nucleic acid of the second polynucleotide sequence at said position; and
(ii) said at least one second numerical parameter does not indicate abnormalities in the first probe data and the second probe data; and
if said determinations are both positive, determining that the nucleic acid of the first sol nucleotide sequence is equal to the nucleic acid of the second polynucleotide sequence at said position.

2. (canceled)

3. A method according to claim 1 in which said at least one second numerical parameter for each said position includes a parameter comparing the mean and the standard deviation of the corresponding first probe data and second probe data.

4. A method according to claim 1 including identifying for each said position the perfect match probe which is the one of the corresponding first probe and second probes having the highest hybridization intensities, and, if either of said determinations is negative, performing a verification algorithm using perfect match data describing the hybridization intensities with the first polynucleotide strand of the respective perfect match probes for the neighbouring positions.

5. A method according to claim 4 in which the verification algorithm comprises a first determination of whether the perfect match data for the neighbouring positions is indicative of a divergence between the nucleic acid of the first and second polynucleotide sequences at said position.

6. A method according to claim 5 in which said first determination is positive if the average of the perfect match data for one or more nearest neighbouring positions is lower than the perfect match data for neighbouring positions further from said position than said nearest neighboring positions.

7. A method according to claim 4 in which the verification algorithm comprises a second determination of whether there is a likelihood of a substitution bias at said position.

8. A method according to claim 7 in which the second determination is calculated as a ratio of:
$${f}_{obs} = \frac{\# ( {b}_{1} {b}_{2} {b}_{3} {b}_{4} )}{\begin{matrix}\# ( {b}_{1} {b}_{2} {b}_{3} {b}_{4} ) + \# ( {b}_{1} {b}_{2} {b}_{4} {b}_{3} ) + \# ( {b}_{1} {b}_{3} {b}_{2} {b}_{4} ) + \\ \# ( {b}_{1} {b}_{3} {b}_{4} {b}_{2} ) + \# ( {b}_{1} {b}_{4} {b}_{2} {b}_{3} ) + \# ( {b}_{1} {b}_{4} {b}_{3} {b}_{2} )\end{matrix}} , \\ and$$
$${f}_{rand} = \frac{\# ( {b}_{1} , {b}_{2} )}{t} \times \frac{\# ( {b}_{2} {b}_{3} )}{t} \times \frac{\# ( {b}_{3} {b}_{4} )}{t} ,$$
wherein b₁ denotes the base encoded by the perfect match probe, b₂, b₃ and b₄ denote the bases encoded by the other of the first and second probes, {b₁, b₂, b₃, b₄}={A, C, G, T}, the hybridization intensity reduction order in the position is b₁b₂b₃, b₄, and for any order of the bases denoted by wxyz, the function #(wxyz) denotes the number of positions, out of a number t of other positions at which the first polynucleotide sequence was determined to be b₁, that the hybridization intensity reduction order was wxyz, and #(wx) denotes #(wxyz)+#(wxzy).

9. A method according to claim 5 in which the verification algorithm comprises a second determination of whether there is a likelihood of a substitution bias at said position, and in which, upon said first determination being positive and said second determination being negative, it is determined that the nucleic acid at the first polynucleotide sequence differs from the second polynucleotide sequence at said position.

10. A method according to claim 1 in which the fragments overlap in more than one part of the second polynucleotide strand.

11. A method according to claim 1 in which the dataset further comprises further data describing the hybridization intensity of the first polynucleotide with one or more sets of plurality of additional mismatch probes,
each set of additional mismatch probes being designed to bind with mutations of a respective hotspot portion of the second polynucleotide strand known to contain a plurality of hotspots, and comprising an additional mismatch probe for every possible mutation of the corresponding hotspot portion of the second nucleotide portion in at least one of the hotspot positions.

12. A method of sequencing a pair of first polynucleotide strands which are complementary strands having complementary first polynucleotide sequences, each first polynucleotide strand resembling a respective second polynucleotide strand, the second polynucleotide strands having complementary respective second polynucleotide sequences, for each corresponding position in the second polynucleotide sequences,
the method employing a data set which, for each said first polynucleotide strand, and for one or more fragment(s) of the respective second polynucleotide sequence, contains:
for each position along each said fragment:
(i) first probe data describing the hybridization intensity of the first of nucleotide strand with a respective first probe designed to bind to a portion of the respective second polynucleotide strand centered at said position; and
(ii) second probe data describing the respective hybridization intensities of the first polynucleotide strand with each of a set of second probes, each said second probe being designed to bind with a respective mutation of the corresponding portion of the respective second polynucleotide sequence which is formed by mutating the corresponding portion of the respective second polynucleotide sequence at said position, the data set including said second probe data for every possible said mutation;
the method comprising, for each said first polynucleotide stand:
for each said position, obtaining from the dataset a first numerical parameter characterizing the hybridization intensity of the first polynucleotide strand with a corresponding first probe in comparison to the hybridization intensities of the first polynucleotide strand with the corresponding second probes;
said first numerical parameter being indicative of whether a nucleic acid of the first polynucleotide sequence is equal to a nucleic acid of the second polynucleotide sequence at said position
at each said position,
obtaining at least one corresponding second numerical parameter indicative of data abnormalities in the first probe data and second probe data relating to said position,
determining whether:
(i) said first numerical parameter indicates that the nucleic acid of the first polynucleotide sequence is equal to the nucleic acid of the respective second polynucleotide sequence at said position; and
(ii) said at least one second numerical parameter does not indicate abnormalities in the first probe data and the second probe data; and
if said determinations are both positive, determining that the nucleic acid of the first polynucleotide sequence is equal to the nucleic acid of the respective second polynucleotide sequence at said position;
the method comprising a verification algorithm being performed upon a determination that said first numerical parameters are indicative of the two first polynucleotide sequences not being complementary in any said position.

13. (canceled)

14. A method according to claim 13, wherein the method further comprises defining the one or more fragments of the second polynucleotide sequence, said defining the one or more fragments including:
identifying one or more critical regions of said second polynucleotide sequence, and
defining at least one of said fragments to include at least one of said critical regions; said critical regions being any one or more of:
(a) drug-binding sites;
(b) structural components; and
(c) mutation hotspots.

15. (canceled)

16. A method according to claim 15, wherein the second polynucleotide sequence comprises at least one sequence selected from the group consisting of SEQ ID NOs:1-8.

17. A method according to claim 15, wherein the second probes are fragments of at least one sequence selected from the group consisting of SEQ ID NOs:1-8 comprising at least one mutation.

18. (canceled)

19. A method according to claim 1, in which the second polynucleotide strand is RNA or DNA of a virus.

20. A method according to claim 1, in which the second polynucleotide strand is of an influenza A virus.

21. A method according to claim 1, in which the second polynucleotide strand is of an H1N1 influenza A virus.

22. A system comprising a processor and a data storage device, the data storage device storing program instructions readable by the processor to cause the processer to sequence a first polynucleotide strand having a first polynucleotide sequence, the first polynucleotide strand resembling a second polynucleotide strand having a known second polynucleotide sequence, said sequencing employing a data set which, for one or more fragment(s) of the second polynucleotide sequence, contains:
for each position along each said fragment:
(i) first probe data describing the hybridization intensity of the first polynucleotide strand with a respective first probe designed to bind to a portion of the second polynucleotide strand centered at said position; and
(ii) second probe data describing the respective hybridization intensities of the first polynucleotide strand with each of a set of second probes, each said second probe being designed to bind with a respective mutation of the corresponding portion of the second polynucleotide sequence which is formed by mutating the corresponding portion of the second polynucleotide sequence at said position, the data set including said second probe data for every possible said mutation;
the sequencing comprising:
for each said position, obtaining from the dataset a first numerical parameter characterizing the hybridization intensity of the first polynucleotide strand with a corresponding first probe in comparison to the hybridization intensities of the first polynucleotide strand with the corresponding second probes;
said first numerical parameter being indicative of whether a nucleic acid of the first polynucleotide sequence is equal to a nucleic acid of the second polynucleotide sequence at said position.
wherein the sequencing further comprises, at each said position,
obtaining at least one corresponding second numerical parameter indicative of data abnormalities in the first probe data and second probe data relating to said position;
determining whether:
(i) said first numerical parameter indicates that the nucleic acid of the first polynucleotide sequence is equal to the nucleic acid of the second polynucleotide sequence at said position; and
(ii) said at least one second numerical parameter does not indicate abnormalities in the first probe data and the second probe data; and
if said determinations are both positive, determining that the nucleic acid of the first polynucleotide sequence is equal to the nucleic acid of the second polynucleotide sequence at said position.

23. A computer program product, such as a tangible data storage device, encoding program instructions readable by a computer processor to cause the processor to sequence a first polynucleotide strand having a first polynucleotide sequence, the first polynucleotide strand resembling a second polynucleotide strand having a known second polynucleotide sequence, the sequencing employing a data set which, for one or more fragment(s) of the second polynucleotide sequence, contains:
for each position along each said fragment:
(i) first probe data describing the hybridization intensity of the first polynucleotide strand with a respective first probe designed to bind to a portion of the second polynucleotide strand centered at said position; and
(ii) second probe data describing the respective hybridization intensities of the first polynucleotide strand with each of a set of second probes, each said second probe being designed to bind with a respective mutation of the corresponding portion of the second polynucleotide sequence which is formed by mutating the corresponding portion of the second polynucleotide sequence at said position, the data set including said second probe data for every possible said mutation;
the sequencing comprising:
for each said position, obtaining from the dataset a first numerical parameter characterizing the hybridization intensity of the first polynucleotide strand with a corresponding first probe in comparison to the hybridization intensities of the first polynucleotide strand with the corresponding second probes;
said first numerical parameter being indicative of whether a nucleic acid of the first polynucleotide sequence is equal to a nucleic acid of the second polynucleotide sequence at said position.
wherein the sequencing further comprises, at each said position,
obtaining at least one corresponding second numerical parameter indicative of data abnormalities in the first probe data and second probe data relating to said position;
determining whether:
(i) said first numerical parameter indicates that the nucleic acid of the first polynucleotide sequence is equal to the nucleic acid of the second polynucleotide sequence at said position; and
(ii) said at least one second numerical parameter does not indicate abnormalities in the first probe data and the second probe data; and
if said determinations are both positive, determining that the nucleic acid of the first polynucleotide sequence is equal to the nucleic acid of the second polynucleotide sequence at said position.

24. A kit comprising:
(a) RT-PCR primers used for amplification,
(b) an array for sequencing a first polynucleotide strand having a first polynucleotide sequence and resembling a second polynucleotide strand having a second, known polynucleotide sequence, the array comprising, for each of one or more fragment(s) of the second polynucleotide sequence:
(i) for each position along each said fragment of the second polynucleotide sequence, a first probe designed to bind to a portion of the second polynucleotide sequence centred at said position; and
(ii) for each first probe, a plurality of second probes, each said second probe being designed to bind with a respective mutation of the corresponding portion of the second polynucleotide sequence which is formed by mutating a nucleic acid of the second polynucleotide sequence at said position, there being a respective said second probe for every possible said mutation; and
(c) a computer readable medium storing computer-readable program instructions readable by a computer processor to cause the processor to sequence the first polynucleotide strand, the sequencing employing a data set which, for each of the one or more fragment(s) of the second polynucleotide sequence, contains:
for each position along each said fragment:
(i) first probe data describing the hybridization intensity of the first polynucleotide strand with the respective first probe; and
(ii) second probe data describing the respective hybridization intensities of the first polynucleotide strand with each of the set of second probes, the data set including said second probe data for every possible said mutation;
the sequencing comprising:
for each said position, obtaining from the dataset a first numerical parameter characterizing the hybridization intensity of the first polynucleotide strand with a corresponding first probe in comparison to the hybridization intensities of the first polynucleotide strand with the corresponding second probes;
said first numerical parameter being indicative of whether a nucleic acid of the first polynucleotide sequence is equal to a nucleic acid of the second polynucleotide sequence at said position.
wherein the sequencing further comprises, at each said position,
obtaining at least one corresponding second numerical parameter indicative of data abnormalities in the first probe data and second probe data relating to said position;
determining whether:
(i) said first numerical parameter indicates that the nucleic acid of the first polynucleotide sequence is equal to the nucleic acid of the second polynucleotide sequence at said position; and
(ii) said at least one second numerical parameter does not indicate abnormalities in the first probe data and the second probe data; and
if said determinations are both positive, determining that the nucleic acid of the first polynucleotide sequence is equal to the nucleic acid of the second polynucleotide sequence at said position.


SEQUENCE LISTING (8 sequences)

SEQ ID NO: 1 - DNA, 2358 bp, Influenza A virus (H1N1)
tagcaaaagcaggtcaaatatattcaatatggagagaataaaagaactgagagatctaatgtcgcagtcccgcactcgcgagatactcactaagaccactgtggaccatatggccataatcaaaaagtacacatcaggaaggcaagagaagaaccccgcactcagaatgaagtggatgatggcaatgagatacccaattacagcagacaagagaataatggacatgattccagagaggaatgaacaaggacaaaccctctggagcaaaacaaacgatgctggatcagaccgagtgatggtatcacctctggccgtaacatggtggaataggaatggcccaacaacaagtacagttcattaccctaaggtatataaaacttatttcgaaaaggtcgaaaggttgaaacatggtaccttcggccctgtccacttcagaaatcaagttaaaataaggaggagagttgatacaaaccctggccatgcagatctcagtgccaaggaggcacaggatgtgattatggaagttgttttcccaaatgaagtgggggcaagaatactgacatcagagtcacagctggcaataacaaaagagaagaaagaagagctccaggattgtaaaattgctcccttgatggtggcgtacatgctagaaagagaattggtccgtaaaacaaggtttctcccagtagccggcggaacaggcagtgtttatattgaagtgttgcacttaacccaagggacgtgctgggagcagatgtacactccaggaggagaagtgagaaatgatgatgttgaccaaagtttgattatcgctgctagaaacatagtaagaagagcagcagtgtcagcagacccattagcatctctcttggaaatgtgccacagcacacagattggaggagtaaggatggtggacatccttagacagaatccaactgaggaacaagccgtagacatatgcaaggcagcaatagggttgaggattagctcatctttcagttttggtgggttcactttcaaaaggacaagcggatcatcagtcaagaaagaagaagaagtgctaacgggcaacctccaaacactgaaaataagagtacatgaagggtatgaagaattcacaatggttgggagaagagcaacagctattctcagaaaggcaaccaggagattgatccagttgatagtaagcgggagagacgagcagtcaattgctgaggcaataattgtggccatggtattctcacaagaggattgcatgatcaaggcagttaggggcgatctgaactttgtcaatagggcaaaccagcgactgaaccccatgcaccaactcttgaggcatttccaaaaagatgcaaaagtgcttttccagaactggggaattgaatccatcgacaatgtgatgggaatgatcggaatactgcccgacatgaccccaagcacggagatgtcgctgagagggataagagtcagcaaaatgggagtagatgaatactccagcacggagagagtggtagtgagtattgaccgatttttaagggttagagatcaaagagggaacgtactattgtctcccgaagaagtcagtgaaacgcaaggaactgagaagttgacaataacttattcgtcatcaatgatgtgggagatcaatggccctgagtcagtgctagtcaacacttatcaatggataatcaggaactgggaaattgtgaaaattcaatggtcacaagatcccacaatgttatacaacaaaatggaatttgaaccatttcagtctcttgtccctaaggcaaccagaagccggtacagtggattcgtaaggacactgttccagcaaatgcgggatgtgcttgggacatttgacactgtccaaataataaaacttctcccctttgctgctgctccaccagaacagagtaggatgcaattttcctcattgactgtgaatgtgagaggatcagggttgaggatactggtaagaggcaattctccagtattcaattacaacaaggcaaccaaacgacttacagttcttggaaaggatgcaggtgcattgactgaagatccagatgaaggcacatctggggtggagtctgctgtcctgagaggatttctcattttgggcaaagaagacaagagatatggcccagcattaagcatcaatgaactgagcaatcttgcaaaaggagagaaggctaatgtgctaattgggcaaggggacgtagtgttggtaatgaaacgaaaacgggactctagcatacttactgacagccagacagcgaccaaaagaattcggatggccatcaattagtgtcgaattgtttaaaaacgaccttgtttctactaggtcatagctgtttc

SEQ ID NO: 2 - DNA, 2334 bp, Influenza A virus (H1N1)
gcaggcaaaccatttgaatggatgtcaatccgactctacttttcctaaaaattccagcgcaaaatgccataagcaccacattcccttatactggagatcctccatacagccatggaacaggaacaggatacaccatggacacagtaaacagaacacaccaatactcagaaaagggaaagtggacgacaaacacagagactggtgcaccccagctcaacccgattgatggaccactacctgaggataatgaaccaagtgggtatgcacaaacagactgtgttctagaggctatggctttccttgaagaatcccacccaggaatatttgagaattcatgccttgaaacaatggaagttgttcaacaaacaagggtagataaactaactcaaggtcgccagacttatgattggacattaaacagaaatcaaccggcagcaactgcattggccaacaccatagaagtctttagatcgaatggcctaacagctaatgagtcaggaaggctaatagatttcttaaaggatgtaatggaatcaatgaacaaagaggaaatagagataacaacccactttcaaagaaaaaggagagtaagagacaacatgaccaagaagatggtcacgcaaagaacaatagggaagaaaaaacaaagactgaataagagaggctatctaataagagcactgacattaaatacgatgaccaaagatgcagagagaggcaagttaaaaagaagggctatcgcaacacctgggatgcagattagaggtttcgtatactttgttgaaactttagctaggagcatttgcgaaaagcttgaacagtctgggctcccagtagggggcaatgaaaagaaggccaaactggcaaatgttgtgagaaagatgatgactaattcacaagacacagagatttctttcacaatcactggggacaacactaagtggaatgaaaatcaaaatcctcgaatgttcctggcgatgattacatatatcaccagaaatcaacccgagtggttcagaaacatcctgagcatggcacccataatgttctcaaacaaaatggcaagactagggaaagggtacatgttcgagagtaaaagaatgaagattcgaacacaaataccagcagaaatgctagcaagcattgacctgaagtacttcaatgaatcaacaaagaagaaaattgagaaaataaggcctcttctaatagatggcacagcatcactgagtcctgggatgatgatgggcatgttcaacatgctaagtacggtcttgggagtctcgatactgaatcttggacaaaagaaatacaccaagacaatatactggtgggatgggctccaatcatccgacgattttgctctcatagtgaatgcaccaaaccatgagggaatacaagcaggagtggacagattctacaggacctgcaagttagtgggaatcaacatgagcaaaaagaagtcctatataaataagacagggacatttgaattcacaagctttttttatcgctatggatttgtggctaattttagcatggagctacccagctttggagtgtctggagtaaatgaatcagctgacatgagtattggagtaacagtgataaagaacaacatgataaacaatgaccttggacctgcaacggcccagatggctcttcaattgttcatcaaagactacagatacacatataggtgccataggggagacacacaaattcagacgagaagatcatttgagttaaagaagctgtgggatcaaacccaatcaaaggtagggctattagtatcagatggaggaccaaacttatacaatatacggaatcttcacattcctgaagtctgcttaaaatgggagctaatggatgatgattatcggggaagactttgtaatcccctgaatccctttgtcagtcataaagagattgattctgtaaacaatgctgtggtaatgccagcccatggtccagccaaaagcatggaatatgatgccgttgcaactacacattcctggattcccaagaggaatcgttctattctcaacacaagccaaaggggaattcttgaggatgaacagatgtaccagaagtgctgcaatctattcgagaaatttttccctagcagttcatataggagaccggttggaatttctagcatggtggaggccatggtgtctagggcccggattgatgccagggtcgacttcgagtctggacggatcaagaaagaagagttctctgagatcatgaagatctgttccaccattgaagaactcagacggcaaaaataatgaatttaacttgtccttcatgaaaaaatgcttgtttctacta

SEQ ID NO: 3 - DNA, 2259 bp, Influenza A virus (H1N1)
ttagcaaaaagcaggtactgatccaaaatggaagactttgtgcgacaatgcttcaatccaatgatcgtcgagcttgcggaaaaggcaatgaaagaatatggggaagatccgaaaatcgaaactaacaagtttgctgcaatatgcacacatttggaagtttgtttcatgtattcggatttccatttcatcgacgaacggggtgaatcaataattgtagaatctggtgacccgaatgcactattgaagcaccgatttgagataattgaaggaagagaccgaatcatggcctggacagtggtgaacagtatatgtaacacaacaggggtagagaagcctaaatttcttcctgatttgtatgattacaaagagaaccggttcattgaaattggagtaacacggagggaagtccacatatattacctagagaaagccaacaaaataaaatctgagaagacacacattcacatcttttcattcactggagaggagatggccaccaaagcggactacacccttgacgaagagagcagggcaagaatcaaaactaggcttttcactataagacaagaaatggccagtaggagtctatgggattcctttcgtcagtccgaaagaggcgaagagacaattgaagaaaaatttgagattacaggaactatgcgcaagcttgccgaccaaagtctcccaccgaacttctccagccttgaaaactttagagcctatgtagatggattcgagccgaacggctgcattgagggcaagctttcccaaatgtcaaaagaagtgaacgccaaaattgaaccattcttgaggacgacaccacgccccctcagattgcctgatgggcctctttgccatcagcggtcaaagttcctgctgatggatgctctgaaattaagtattgaagacccgagtcacgagggggagggaataccactatatgatgcaatcaaatgcatgaagacattctttggctggaaagagcctaacatagtcaaaccacatgagaaaggcataaatcccaattacctcatggcttggaagcaggtgctagcagagctacaggacattgaaaatgaagagaagatcccaaggacaaagaacatgaagagaacaagccaattgaagtgggcactcggtgaaaatatggcaccagaaaaagtagactttgatgactgcaaagatgttggagaccttaaacagtatgacagtgatgagccagagcccagatctctagcaagctgggtccaaaatgaattcaataaggcatgtgaattgactgattcaagctggatagaacttgatgaaataggagaagatgttgccccgattgaacatatcgcaagcatgaggaggaactattttacagcagaagtgtcccactgcagggctactgaatacataatgaagggagtgtacataaatacggccttgctcaatgcatcctgtgcagccatggatgactttcagctgatcccaatgataagcaaatgtaggaccaaagaaggaagacggaaaacaaacctgtatgggttcattataaaaggaaggtctcatttgagaaatgatactgatgtggtgaactttgtaagtatggagttctcactcactgacccgagactggagccacacaaatgggaaaaatactgtgttcttgaaataggagacatgctcttgaggactgcgataggccaagtgtcgaggcccatgttcctatatgtgagaaccaatggaacctccaagatcaagatgaaatggggcatggaaatgaggcgctgccttcttcagtctcttcagcagattgagagcatgattgaggccgagtcttctgtcaaagagaaagacatgaccaaggaattctttgaaaacaaatcggaaacatggccaatcggagagtcacccaggggagtggaggaaggctctattgggaaagtgtgcaggaccttactggcaaaatctgtattcaacagtctatatgcgtctccacaacttgaggggttttcggctgaatcgagaaaattgcttctcattgttcaggcacttagggacaacctggaacctggaaccttcgatcttggggggctatatgaagcaatcgaggagtgcctgattaatgatccctgggttttgcttaatgcatcttggttcaactccttcctcacacatgcactgaagtagttgtggcaatgctactatttgctatccatactgtccaaaaaggtaccttgtttctactgtctactgttttttttcctcgaa

SEQ ID NO: 4 - DNA, 1772 bp, Influenza A virus (H1N1)
acgactagcaaaagcaggggaaaacaaaagcaacaaaaatgaaggcaatactagtagttctgctatatacatttgcaaccgcaaatgcagacacattatgtataggttatcatgcgaacaattcaacagacactgtagacacagtactagaaaagaatgtaacagtaacacactctgttaaccttctagaagacaagcataacgggaaactatgcaaactaagaggggtagccccattgcatttgggtaaatgtaacattgctggctggatcctgggaaatccagagtgtgaatcactctccacagcaagctcatggtcctacattgtggaaacatctagttcagacaatggaacgtgttacccaggagatttcatcgattatgaggagctaagagagcaattgagctcagtgtcatcatttgaaaggtttgagatattccccaagacaagttcatggcccaatcatgactcgaacaaaggtgtaacggcagcatgtcctcatgctggagcaaaaagcttctacaaaaatttaatatggctagttaaaaaaggaaattcatacccaaagctcagcaaatcctacattaatgataaagggaaagaagtcctcgtgctatggggcattcaccatccatctactagtgctgaccaacaaagtctctatcagaatgcagatgcatatgtttttgtggggtcatcaagatacagcaagaagttcaagccggaaatagcaataagacccaaagtgagggatcaagaagggagaatgaactattactggacactagtagagccgggagacaaaataacattcgaagcaactggaaatctagtggtaccgagatatgcattcgcaatggaaagaaatgctggatctggtattatcatttcagatacaccagtccacgattgcaatacaacttgtcagacacccaagggtgctataaacaccagcctcccatttcagaatatacatccgatcacaattggaaaatgtccaaaatatgtaaaaagcacaaaattgagactggccacaggattgaggaatgtcccgtctattcaatctagaggcctatttggggccattgccggtttcattgaaggggggtggacagggatggtagatggatggtacggttatcaccatcaaaatgagcaggggtcaggatatgcagccgacctgaagagcacacagaatgccattgacgagattactaacaaagtaaattctgttattgaaaagatgaatacacagttcacagcagtaggtaaagagttcaaccacctggaaaaaagaatagagaatttaaataaaaaagttgatgatggtttcctggacatttggacttacaatgccgaactgttggttctattggaaaatgaaagaactttggactaccacgattcaaatgtgaagaacttatatgaaaaggtaagaagccagttaaaaaacaatgccaaggaaattggaaacggctgctttgaattttaccacaaatgcgataacacgtgcatggaaagtgtcaaaaatgggacttatgactacccaaaatactcagaggaagcaaaattaaacagagaagaaatagatggggtaaagctggaatcaacaaggatttaccagattttggcgatctattcaactgtcgccagttcattggtactggtagtctccctgggggcaatcagtttctggatgtgctctaatgggtctctacagtgtagaatatgtatttaacattaggatttcagaagcatgagaaaaacactt

SEQ ID NO: 5 - DNA, 1576 bp, Influenza A virus (H1N1)
ttagcaaaaggtagggtagataatcactcaatgagtgacatcgaagccatggcgtctcaaggcaccaaacgatcatatgaacaaatggagactggtggggagcgccaggatgccacagaaatcagagcatctgtcggaagaatgattggtggaatcgggagattctacatccaaatgtgcactgaactcaaactcagtgattatgatggacgactaatccagaatagcataacaatagagaggatggtgctttctgcttttgatgagagaagaaataaatacctagaagagcatcccagtgctgggaaggaccctaagaaaacaggaggacccatatatagaagaatagacggaaagtggatgagagaactcatcctttatgacaaagaagaaataaggagagtttggcgccaagcaaacaatggcgaagatgcaacagcaggtcttactcatatcatgatttggcattccaacctgaatgatgccacatatcagagaacaagagcgcttgttcgcaccggaatggatcccagaatgtgctctctaatgcaaggttcaacacttcccagaaggtctggtgccgcaggtgctgcggtgaaaggagttggaacaatagcaatggagttaatcagaatgatcaaacgtggaatcaatgaccgaaatttctggaggggtgaaaatggacgaaggacaagggttgcttatgaaagaatgtgcaatatcctcaaaggaaaatttcaaacagctgcccagagggcaatgatggatcaagtaagagaaagtcgaaacccaggaaacgctgagattgaagacctcattttcctggcacggtcagcactcattctgaggggatcagttgcacataaatcctgcctgcctgcttgtgtgtatgggcttgcagtagcaagtgggcatgactttgaaagggaagggtactcactggtcgggatagacccattcaaattactccaaaacagccaagtggtcagcctgatgagaccaaatgaaaacccagctcacaagagtcaattggtgtggatggcatgccactctgctgcatttgaagatttaagagtatcaagtttcataagaggaaagaaagtgattccaagaggaaagctttccacaagaggggtccagattgcttcaaatgagaatgtggaaaccatggactccaataccctggaactaagaagcagatactgggccataaggaccaggagtggaggaaataccaatcaacaaaaggcatccgcaggccagatcagtgtgcagcctacattctcagtgcagcggaatctcccttttgaaagagcaaccgttatggcagcattcagcgggaacaatgaaggacggacatccgacatgcgaacagaagttataagaatgatggaaagtgcaaagccagaagatttgtccttccaggggcggggagtcttcgagctctcggacgaaaaggcaacgaacccgatcgtgccttcctttgacatgagtaatgaagggtcttatttcttcggagacaatgcagaggagtatgacagttgaggaaaaatacccttgtttctactaggtcata

SEQ ID NO: 6 - DNA, 1458 bp, Influenza A virus (H1N1)
agcaaaagcaggagtttaaaatgaatccaaaccaaaagataataaccattggttcggtctgtatgacaattggaatggctaacttaatattacaaattggaaacataatctcaatatggattagccactcaattcaacttgggaatcaaaatcagattgaaacatgcaatcaaagcgtcattacttatgaaaacaacacttgggtaaatcagacatatgttaacatcagcaacaccaactttgctgctggacagtcagtggtttccgtgaaattagcgggcaattcctctctctgccctgttagtggatgggctatatacagtaaagacaacagtataagaatcggttccaagggggatgtgtttgtcataagggaaccattcatatcatgctcccccttggaatgcagaaccttcttcttgactcaaggggccttgctaaatgacaaacattccaatggaaccattaaagacaggagcccatatcgaaccctaatgagctgtcctattggtgaagttccctctccatacaactcaagatttgagtcagtcgcttggtcagcaagtgcttgtcatgatggcatcaattggctaacaattggaatttctggcccagacaatggggcagtggctgtgttaaagtacaacggcataataacagacactatcaagagttggagaaacaatatattgagaacacaagagtctgaatgtgcatgtgtaaatggttcttgctttactgtaatgaccgatggaccaagtgatggacaggcctcatacaagatcttcagaatagaaaagggaaagatagtcaaatcagtcgaaatgaatgcccctaattatcactatgaggaatgctcctgttatcctgattctagtgaaatcacatgtgtgtgcagggataactggcatggctcgaatcgaccgtgggtgtctttcaaccagaatctggaatatcagataggatacatatgcagtgggattttcggagacaatccacgccctaatgataagacaggcagttgtggtccagtatcgtctaatggagcaaatggagtaaaaggattttcattcaaatacggcaatggtgtttggatagggagaactaaaagcattagttcaagaaacggttttgagatgatttgggatccgaacggatggactgggacagacaataacttctcaataaagcaagatatcgtaggaataaatgagtggtcaggatatagcgggagttttgttcagcatccagaactaacagggctggattgtataagaccttgcttctgggttgaactaatcagagggcgacccaaagagaacacaatctggactagcgggagcagcatatccttttgtggtgtaaacagtgacactgtgggttggtcttggccagacggtgctgagttgccatttaccattgacaagtaatttgttcaaaaaactccttgtttctact

SEQ ID NO: 7 - DNA, 1032 bp, Influenza A virus (H1N1)
cagggagcaaaagcaggtagatatttaaagatgagtcttctaaccgaggtcgaaacgtacgttctttctatcatcccgtcaggccccctcaaagccgagatcgcgcagagactggaaagtgtctttgcaggaaagaacacagatcttgaggctctcatggaatggctaaagacaagaccaatcttgtcacctctgactaagggaattttaggatttgtgttcacgctcaccgtgcccagtgagcgaggactgcagcgtagacgctttgtccaaaatgccctaaatgggaatggggacccgaacaacatggatagagcagttaaactatacaagaagctcaaaagagaaataacgttccatggggccaaggaggtgtcactaagctattcaactggtgcacttgccagttgcatgggcctcatatacaacaggatgggaacagtgaccacagaagctgcttttggtctagtgtgtgccacttgtgaacagattgctgattcacagcatcggtctcacagacagatggctactaccaccaatccactaatcaggcatgaaaacagaatggtgctggctagcactacggcaaaggctatggaacagatggctggatcgagtgaacaggcagcggaggccatggaggttgctaatcagactaggcagatggtacatgcaatgagaactattgggactcatcctagctccagtgctggtctgaaagatgaccttcttgaaaatttgcaggcctaccagaagcgaatgggagtgcagatgcagcgattcaagtgatcctctcgtcattgcagcaaatatcattgggatcttgcacctgatattgtggattactgatcgtctttttttcaaatgtatttatcgtcgctttaaatacggtttgaaaagagggccttctacggaaggagtgcctgagtccatgagggaagaatatcaacaggaacagcagagtgctgtggatgttgacgatggtcattttgtcaacatagagctagagtaaaaaactaccttgtttctaca

SEQ ID NO: 8 - DNA, 892 bp, Influenza A virus (H1N1)
ggagcaaaagcagggtgacaaaaacataatggactccaacaccatgtcaagctttcaggtagactgtttcctttggcatatccgcaagcgatttgcagacaatggattgggtgatgccccattccttgatcggctccgccgagatcaaaagtccttaaaaggaagaggcaacacccttggcctcgatatcgaaacagccactcttgttgggaaacaaatcgtggaatggatcttgaaagaggaatccagcgagacacttagaatgacaattgcatctgtacctacttcgcgctacctttctgacatgaccctcgaggaaatgtcacgagactggttcatgctcatgcctaggcaaaagataataggccctctttgcgtgcgattggaccaggcgatcatggaaaagaacatagtactgaaagcgaacttcagtgtaatctttaaccgattagagaccttgatactactaagggctttcactgaggagggagcaatagttggagaaatttcaccattaccttctcttccaggacatacttatgaggatgtcaaaaatgcagttggggtcctcatcggaggacttgaatggaatggtaacacggttcgagtctctgaaaatatacagagattcgcttggagaaactgtgatgagaatgggagaccttcactacctccagagcagaaatgaaaagtggcgagagcaattgggacagaaatttgaggaaataaggtggttaattgaagaaatgcggcacagattgaaagcgacagagaatagtttcgaacaaataacatttatgcaagccttacaactactgcttgaagtagaacaagagataagagctttctcgtttcagcttatttaatgataaaaaacacccttgtttctact